(19) United States
(12) Patent Application Publication
(10) Pub. No.: US 2012/0261611 A1
(43) Pub. Date: Oct. 18, 2012

(54) RARE EARTH REMOVAL OF PHOSPHORUS-CONTAINING MATERIALS

(75) Inventors: Carl Hassler, Gig Harbor, WA (US); John Burba, Parker, CO (US); Robert Cable, Las Vegas, NV (US)

(73) Assignee: MOLYCORP MINERALS, LLC, Greenwood Village, CO (US)

(21) Appl. No.: 13/432,895

(22) Filed: Mar. 28, 2012

Related U.S. Application Data
(63) Continuation-in-part of application No. 13/356,574, filed on Jan. 23, 2012.
(60) Provisional application No. 61/474,902, filed on Apr. 13, 2011.
(60) Provisional application No. 61/475,155, filed on Apr. 13, 2011.
(60) Provisional application No. 61/539,780, filed on Sep. 27, 2011.
(60) Provisional application No. 61/476,667, filed on Apr. 18, 2011.
(60) Provisional application No. 61/553,809, filed on Oct. 31, 2011.
(60) Provisional application No. 61/558,887, filed on Nov. 11, 2011.
(60) Provisional application No. 61/564,132, filed on Nov. 28, 2011.
(60) Provisional application No. 61/614,427, filed on Mar. 22, 2012.
(60) Provisional application No. 61/613,857, filed on Mar. 21, 2012.
(60) Provisional application No. 61/538,634, filed on Sep. 23, 2011.
(60) Provisional application No. 61/613,883, filed on Mar. 21, 2012.
(60) Provisional application No. 61/614,418, filed on Mar. 22, 2012.

(51) Int. Cl. C02F 1/42; C02F 1/72; C02F 1/70; C09K 3/00; C02F 1/58

(52) U.S. Cl. 252/182.3; 252/182.35; 210/660; 210/691; 210/668; 210/685

(57) ABSTRACT

This disclosure relates generally to methods and rare earth-containing additives for removing inorganic and organic phosphorus-containing target materials.

### CROSS REFERENCE TO RELATED APPLICATIONS

The present application is a Continuation-in-Part of U.S. application Ser. No. 13/356,574 filed Jan. 23, 2012 and claims the benefit of U.S. Provisional Application Ser. Nos.:

61/474,902, with a filing date of Apr. 13, 2011, entitled “Process for Treating Waters and Water Handling Systems Using Rare Earth Metals”;

61/475,155, with a filing date of Apr. 13, 2011, entitled “Methods and Devices for Removing Oxyanions Using Reduction/Oxidation and Soluble and Insoluble Rare Earths”;

61/539,780, with a filing date of Sep. 27, 2011, entitled “Method for Removing Target Materials From a Fluid Stream using Rare Earths and/or a Rare Earth-Containing Additive”;

61/476,667, with a filing date of Apr. 18, 2011, entitled “Process for Treating Waters and Water Handling Systems Using Rare Earth Metals”;

61/553,809, with a filing date of Oct. 31, 2011, entitled “Process for Treating Waters and Water Handling Systems Using Rare Earth Metals”;

61/558,887, with a filing date of Nov. 11, 2011, entitled “Process for Treating Waters and Water Handling Systems Using Rare Earth Metals”,

61/564,132, with a filing date of Nov. 28, 2011, entitled “Process for Treating Waters and Water Handling Systems Using Rare Earth Metals”;

61/614,427, with a filing date of Mar. 22, 2012, entitled “Rare Earth Removal of Hydrated and Hydroxyl Species”;

61/613,857, with a filing date of Mar. 21, 2012, entitled “Non-Metal Containing Oxyanion Removal from Waters Using Rare Earths”;

61/538,634, with a filing date of Sep. 23, 2011, entitled “Rare Earth Contaminant Removal in Pools, Hot Tubs, and Spas”;

61/613,883, with a filing date of Mar. 21, 2012, entitled “Rare Earth Removal of Phosphorus-Containing Materials”;

61/614,418, with a filing date of Mar. 22, 2012, entitled “Rare Earth Removal of Phosphorus-Containing Materials”;

each of which is incorporated in its entirety herein by this reference.

Cross reference is made to U.S. patent application Ser. No. 13/244,092 filed Sep. 23, 2011, entitled “PROCESS FOR TREATING WATERS AND WATER HANDLING SYSTEMS TO REMOVE SCALES AND REDUCE THE SCALING TENDENCY” having attorney docket no. 6062-89-3;

Cross reference is made to U.S. patent application Ser. No. 13/410,081, filed Mar. 1, 2012, entitled “Contaminant Removal from Waters Using Rare Earths” having attorney docket no. 6062-89-1;

Cross reference is made to U.S. patent application Ser. No. 13/356,581, filed Jan. 23, 2012, entitled “Rare Earth Removal of Hydrated and Hydroxyl Species” having attorney docket no. 6062-89-6;

Cross reference is made to U.S. patent application Ser. No. 13/244,117, filed Sep. 23, 2011, entitled “Particulate Cerium Dioxide and an In Situ Method for Making and Using the Same” having attorney docket no. 6062-89-4;

Cross reference is made to U.S. patent application Ser. No. ______ filed Mar. 28, 2012, entitled “NON-METAL-CONTAINING OXYANION REMOVAL FROM WATERS USING RARE EARTHS” having attorney docket no. 6062-89-2, which is incorporated herein by this reference in its entirety.

Cross reference is made to U.S. patent application Ser. No. ______ filed Mar. 28, 2012, entitled “RARE EARTH REMOVAL OF HYDRATED AND HYDROXYL SPECIES” having attorney docket no. 6062-89-6-CIP, which is incorporated herein by this reference in its entirety.

### FIELD OF INVENTION

The present disclosure is related generally to removal of phosphorus-containing target materials from a fluid stream using a rare earth, more particularly to removal of phosphorus-containing materials from an aqueous stream using a rare earth.

### BACKGROUND OF THE INVENTION

As fresh water resources grow increasingly scarce, water quality is rapidly becoming a major global concern. Various technologies have been used to remove contaminants from municipal, industrial, and recreational waters. Examples of such techniques include adsorption on high surface area materials, such as alumina and activated carbon, ion exchange with anion exchange resins, co-precipitation and electrodialysis. However, most technologies for contaminant removal are hindered by the difficulty of removing problematic contaminants, more particularly the difficulty of removing phosphorus-containing contaminants, such as inorganic and/or inorganic phosphorus-containing materials.

### SUMMARY OF THE INVENTION

These and other needs are addressed by the various embodiments and configurations of this disclosure. This disclosure relates generally to methods and rare earth-containing additives for removing inorganic and organic phosphorus-containing target materials.

In one embodiment, a method includes the step of contacting an aqueous medium comprising a phosphorus-containing target material with a rare earth-containing additive to remove at least a portion of the phosphorus-containing target material from the aqueous medium to form a treated aqueous medium. The phosphorus-containing target material includes one or more of phosphoric acid, phosphorus acid, polyphosphoric acids, inorganic phosphite, organic phosphite, phosphorus oxyhalide, phosphorus trihalide, phosphorus pentahalide, cyclic or non-cyclic phosphate salt, organophosphite, chalcogenide, diphosphene, phospho-imide, phosphaalkene, phosphaalkyne, phosphine oxide, phosphinate, phosphine, phosphinite, non-fluoridated phosphonates, o-alkyl phosphoramideocyanidate, phosphonic acid, phosphinic acid, phosphone oxide, phosphonite, phosphonium salt, alkyl phosphonyldihalide, dialkyl phosphoramidic dihalide, alkyl phosphoramidate, phosphorane, phosphono carboxylate, halosoman, Amiton™, alkyl phosphite, DNA backbone phosphate group, DNA backbone phosphite groups thiophosphate and thiophosphyoryl ester, thioester and/or amide, phosphatidylcholine, P—N amino compound, and an alklylated or protonated ester and salt thereof.

In one embodiment, a process includes the steps of:

(a) receiving an aqueous medium comprising both reactive and non-reactive phosphates; and

(b) contacting the aqueous medium with a (water soluble, partly soluble, and/or insoluble) rare earth-containing additive to remove most, if not all, of the reactive and non-reactive phosphates. In one configuration, the reactive phosphate is in the form of an anion, and the non-reactive phosphate in the form of an anion, cation, neutral species, and/or colloid or suspension. Before the contacting step, a portion of the non-reactive phosphate can be converted into reactive phosphate or vice versa.

The method and process can include further steps in other configurations.

In one configuration, the method includes the sub-steps of:

contacting the aqueous medium with an oxidizing agent with the phosphorus-containing target material to form an oxidized phosphorus-containing target material, the oxidized phosphorus-containing target material having one of a different structure and/or composition than the phosphorus-containing target material; and

thereafter contacting, in the aqueous medium, the rare earth-containing additive with the oxidized target material to remove the oxidized target material.

In one configuration, the method and process include the sub-steps of:

contacting the aqueous medium with a reducing agent to reduce the phosphorus-containing target material to form a reduced phosphorus-containing target material, the reduced phosphorous-containing target material having one of a different structure and/or composition than the phosphorus-containing target material; and

thereafter contacting, in the aqueous medium, the rare earth-containing additive with the reduced phosphorus-containing target material to remove the reduced phosphorus-containing target material from the aqueous medium.

In one configuration, the method and process include the sub-steps of:

contacting the aqueous medium with a base and/or base equivalent to convert the phosphorus-containing target material to a primary species different from the phosphorus-containing target material; and

thereafter contacting, in the aqueous medium, the rare earth-containing additive with the primary species to remove the primary species.

In one configuration, the method and process include the sub-steps of:

contacting the aqueous medium with an acid and/or acid equivalent to convert the phosphorus-containing target material to a primary species different from the phosphorus-containing target material; and

thereafter contacting, in the aqueous medium, the rare earth-containing additive with the primary species to remove the primary species.

In an embodiment, a composition includes:

an aqueous medium,

a rare earth-containing additive,

a phosphorus-containing target material comprising one or more of phosphoric acid, phosphorus acid, inorganic phosphite, organic phosphite, phosphorus oxyhalide, phosphorus trihalide, phosphorus pentahalide, cyclic or non-cyclic phosphate salt, organophosphite, chalcogenide, diphosphene, phospho-imide, phosphaalkene, phosphaalkyne, phosphine oxide, phosphinate, phosphine, phosphinite, non-fluoridated phosphonates, o-alkyl phosphoramideocyanidate, phosphonic acid, phosphinic acid, phosphone oxide, phosphonite, phosphonium salt, alkyl phosphonyldihalide, dialkyl phosphoramidic dihalide, alkyl phosphoramidate, phosphorane, phosphono carboxylate, halosoman, amiton, alkyl phosphite, DNA backbone phosphate group, DNA backbone phosphite groups thiophosphate and thiophosphyoryl ester, thioester and/or amide, phosphatidylcholine, P—N amino compound, and an alklylated or protonated ester and salt thereof, and

a target-laden rare earth composition formed by the rare earth-containing additive and the phosphorus-containing target material.

In one application, the rare earth-containing additive comprises primarily cerium, and the target-laden rare earth composition is a complex formed by complexion of the rare earth-containing additive and target material.

In one application, the rare earth-containing additive comprises primarily cerium, and the target-laden rare earth composition is formed by sorption of the phosphorus-containing target material by the rare earth-containing additive.

In one application, the rare earth-containing additive comprises primarily cerium, and the target-laden rare earth composition is formed by a chemical reaction between the phosphorus-containing target material and the rare earth-containing additive.

In the above embodiments, the rare earth-containing additive can be water soluble, partially soluble, partially insoluble, and/or insoluble.

In some applications, the phosphorus-containing target material is selected from the group consisting essentially of phosphoric acid, phosphorus acid, phosphonic acid, phosphinic acid, and alklylated or protonated esters and salts thereof.

In some applications, the phosphorus-containing target material comprises an organic and/or inorganic phosphite.

In some applications, the phosphorus-containing target material comprises one or more of a phosphorus oxyhalide, phosphorus trihalide, alkyl phosphorus oxyhalide, phosphorus pentahalide, cyclic phosphate, chalcogenide, diphosphene, phospho-imide, phosphaalkene, and phosphaalkyne.

In some applications, the phosphorus-containing target material comprises one or more of a phosphine oxide, phosphinate, phosphine, phosphinite, non-fluoridated phosphonate, o-alkyl phosphoramideocyanidate, phosphone oxide, phosphonite, phosphonium salt, alkyl phosphonyldihalide, dialkyl phosphoramidic dihalide, alkyl phosphoramidate, phosphorane, phosphono carboxylate, halosoman, amiton, and alkyl phosphite.

In one embodiment, a process includes the steps of:

(a) receiving an aqueous medium comprising non-reactive phosphates; and

(b) contacting the aqueous medium with a (water soluble, partly soluble, and/or insoluble) rare earth-containing additive to remove most, if not all, of the non-reactive phosphates. In one configuration, the non-reactive phosphate is in the form of an anion, cation, neutral species, and/or colloid or suspension. In some configurations, before the contacting step, a portion of the aqueous media may contain reactive phosphates, the reactive phosphates being converted to non-reactive phosphates prior to the contacting step. Preferably, the reactive phosphate is in the form of an anion and may be in the form of colloid or suspension.

In one embodiment, a process includes the steps of:

(a) receiving an aqueous medium comprising reactive phosphates; and

(b) contacting the aqueous medium with a (water soluble, partly soluble, and/or insoluble) rare earth-containing additive to remove most, if not all, of the reactive phosphates. In some configurations, before the contacting step, a portion of the aqueous media may contain non-reactive phosphates, the non-reactive phosphates being converted to reactive phosphates prior to the contacting step. Preferably, the non-reactive phosphate is in the form of an anion, cation, neutral species, and/or colloid or suspension.

In some applications, the phosphorus-containing target material comprises one or more of a DNA backbone phosphate group, DNA backbone phosphite group, thiophosphate and thiophosphyoryl ester, thioester and amide, phosphatidylcholine, and P—N amino compound.

The disclosure can have a number of advantages. For example, the rare earth-containing composition can remove effectively a large number of phosphorus-containing target materials, whether in the form of dissolved or undissolved species. As an illustration, the rare earth-containing composition can remove organophosphates and organophosphites. The pH and/or Eh can be adjusted to produce a selected primary target material species, which is removed more effectively by the rare earth composition than other target material species. High levels of removal of the primary target material can be therefore realized.

These and other advantages will be apparent from the disclosure.

As used herein, the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

“Absorption” refers to the penetration of one substance into the inner structure of another substance, as distinguished from adsorption.

“Adsorption” refers to the adherence of atoms, ions, molecules, polyatomic ions, or other substances to the surface of another substance, called the adsorbent. Typically, the attractive force for adsorption can be in the form of a bond and/or force, such as covalent bonds, metallic bonds, coordination bonds, ionic bonds, hydrogen bonds, electrostatic forces (e.g., van der Waal's forces and London's forces), and the like.

“At least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “water” refers to any aqueous stream. The water may originate from any aqueous stream may be derived from any natural and/or industrial source. Non-limiting examples of such aqueous streams and/or waters are drinking waters, potable waters, recreational waters, waters derived from manufacturing processes, wastewaters, pool waters, spa waters, cooling waters, boiler waters, process waters, municipal waters, sewage waters, agricultural waters, ground waters, power plant waters, remediation waters, co-mingled water and combinations thereof.

The terms “agglomerate” and “aggregate” refer to a composition formed by gathering one or more materials into a mass.

The term “amide” generally refers to an organic material containing the functional group consisting of a carbonyl group (R—C═O) linked to a nitrogen atom (N).

The term “amino acid” are organic materials containing an amine group, a carboxylic acid group, and a side-chain that is specific to each amino acid. The key elements of an amino acid are carbon, hydrogen, oxygen, and nitrogen.

A “binder” generally refers to one or more substances that bind together a material being agglomerated. Binders are typically solids, semi-solids, or liquids. Non-limiting examples of binders are polymeric materials, tar, pitch, asphalt, wax, cement water, solutions, dispersions, powders, silicates, gels, oils, alcohols, clays, starch, silicates, acids, molasses, lime, lignosulphonate oils, hydrocarbons, glycerin, stearate, or combinations thereof. The binder may or may not chemically react with the material being agglomerated. Non-liming examples of chemical reactions include hydration/dehydration, metal ion reactions, precipitation/gelation reactions, and surface charge modification.

A “carbon-containing radical”, such as R¹, R², R³ or such, generally refers to one or more of: an alkyl group; an aryl group; a C₁ to C₂₅ straight-chain, branched aliphatic hydrocarbon radical; a C₅ to C₃₀ cycloaliphatic hydrocarbon radical; a C₆ to C₃₀ aromatic hydrocarbon radical; a C₇ to C₄₀ alkylaryl radical; a C₂ to C₂₅ linear or branched aliphatic hydrocarbon radical having interruption by one or more heteroatoms, such as, oxygen, nitrogen or sulfur; a C₂ to C₂₅ linear or branched aliphatic hydrocarbon radical having interruption by one or more functionalities selected from the group consisting essentially of a carbonyl (—C(═O)—), an ester (—C(═O)O—), an amide (—C(═O)NH₀₋₂—), a C₂ to C₂₅ linear or branched aliphatic hydrocarbon radical functionalized with one or more of Cl, Br, F, I, NH_{(1 or 2)}, OH, and SH; a C₅ to C₃₀ cycloaliphatic hydrocarbon radical functionalized with one or more of Cl, Br, F, I, NH_{(1 or 2)}, OH, and SH; and a C₇ to C₄₀ alkylaryl radical functionalized with one or more of Cl, Br, F, I, NH_{(0, 1 or 2)}, OH, and SH.

The term “chalcogenide” generally refers to a phosphorus-containing compound having the general formula R₃PE, wherein E═S, Se or Te.

The term “clarification” or “clarify” refers to the removal of suspended and, possibly, colloidal solids by gravitational settling techniques.

The term “coagulation” refers to the destabilization of colloids by neutralizing the forces that keep colloidal materials suspended. Cationic coagulants provide positive electrical charge to reduce the negative charge (zeta potential) of the colloids. The colloids thereby form larger particles (known as flocs).

The term “composition” generally refers to one or more chemical units composed of one or more atoms, such as a molecule, polyatomic ion, chemical compound, coordination complex, coordination compound, and the like. As will be appreciated, a composition can be held together by various types of bonds and/or forces, such as covalent bonds, metallic bonds, coordination bonds, ionic bonds, hydrogen bonds, electrostatic forces (e.g., van der Waal's forces and London's forces), and the like.

“Chemical species” or “species” are atoms, elements, molecules, molecular fragments, ions, compounds, and other chemical structures. “Chemical transformation” refers to process where at least some of a material has had its chemical composition transformed by a chemical reaction.

A “chemical transformation” differs from “a physical transformation”. A physical transformation refers to a process where the chemical composition has not been chemically transformed but a physical property, such as size or shape, has been transformed.

The term “contained within the water” generally refers to materials suspended and/or dissolved within the water. Water is typically a solvent for dissolved materials and water-soluble material. Furthermore, water is typically not a solvent for water-insoluble materials. Suspended materials are substantially insoluble in water and dissolved materials are substantially soluble in water. The suspended materials have a particle size.

“De-toxify” or “de-toxification” includes rendering a phosphorus-containing target material non-toxic or non-harmful to a living organism, such as, for example, a human or other animal. The phosphorus-containing target material may be rendered non-toxic by converting the phosphorus-containing target material into a non-toxic or non-harmful form and/or species.

The term “digest” or “digestion” refers to the use of microorganisms, particularly bacteria, to digest target materials. This is commonly established by mixing forcefully contaminated water with bacteria and molecularly oxygen.

The term “diphosphene” generally refers to a phosphorus-containing compound having the general structure R₂P₂.

The term “disinfect” or “disinfecting” refers to the use of an antimicrobial agent to kill or inhibit the growth of microorganisms, such as bacteria, fungi, protozoans, and viruses. Common antimicrobial agents include, oxidants, reductants, alcohols, aldehydes, halogens, phenolics, quaternary ammonium compounds, silver, copper, ultraviolet light, and other materials.

The term “flocculation” refers to a process using a flocculant, which is typically a polymer, to form a bridge between flocs and bind the particles into large agglomerates or clumps. Bridging occurs when segments of the polymer chain adsorb on different particles and help particles aggregate.

The term “fluid” refers to a liquid, gas or both.

A “halogen” is a nonmetal element from Group 17 IUPAC Style (formerly: VII, VIIA) of the periodic table, comprising fluorine (F), chlorine (Cl), bromine (Br), iodine (I), and astatine (At). The artificially created element 117, provisionally referred to by the systematic name ununseptium, may also be a halogen. A “halide compound” is a compound having as one part of the compound at least one halogen atom and the other part the compound is an element or radical that is less electronegative (or more electropositive) than the halogen. The halide compound is typically a fluoride, chloride, bromide, iodide, or astatide compound. Many salts are halides having a halide anion. A halide anion is a halogen atom bearing a negative charge. The halide anions are fluoride (F), chloride (Cl⁻), bromide (Br), iodide (I) and astatide (At⁻).

The term “phospho-imide” generally refers to a phosphorus-containing compound having the general formula R₃PNR′.

The term “inorganic material” generally refers to a chemical compound or other species that is not organic.

The term “insoluble” refers to materials that are intended to be and/or remain as solids in water. Insoluble materials are able to be retained in a device, such as a column, or be readily recovered from a batch reaction using physical means, such as filtration. Insoluble materials should be capable of prolonged exposure to water, over weeks or months, with little loss of mass. Typically, a little loss of mass refers to less than about 5% mass loss of the insoluble material after a prolonged exposure to water.

An “ion” generally refers to an atom or group of atoms having a charge. The charge on the ion may be negative or positive.

“Organic carbons” or “organic material” generally refer to any compound of carbon except such binary compounds as carbon oxides, the carbides, carbon disulfide, etc.; such ternary compounds as the metallic cyanides, metallic carbonyls, phosgene, carbonyl sulfide, etc.; and the metallic carbonates, such as alkali and alkaline earth metal carbonates. Exemplary organic carbons include humic acid, tannins, and tannic acid, polymeric materials, alcohols, carbonyls, carboxylic acids, oxalates, amino acids, hydrocarbons, and mixtures thereof. In some embodiments, the phosphorus-containing target material is an organic material as defined herein. An alcohol is any organic compound in which a hydroxyl functional group (—OH) is bound to a carbon atom, the carbon atom is usually connected to other carbon or hydrogen atoms. Examples of alcohols include acyclic alcohols, isopropyl alcohol, ethanol, methanol, pentanol, polyhydric alcohols, unsaturated aliphatic alcohols, and alicyclic alcohols, and the like. The carbonyl group is a functional group consisting of a carbonyl (RR′C═O) (where R and R′ vary independently and may be H or any organic radical, R and R′ may be the same or differ). Examples of organic compounds containing a carbonyl group include aldehydes, ketones, esters, amides, enones, acyl halides, acid anhydrides, urea, and carbamates and derivatives thereof, and the derivatives of acyl chlorides chloroformates and phosgene, carbonate esters, thioesters, lactones, lactams, hydroxamates, and isocyanates. Preferably, the carbonyl group comprises a carboxylic acid group, which has the formula —C(═O)OH, usually written as —COOH or —CO₂H. Examples of organic compounds containing a carboxyl group include carboxylic acid (R—COOH) and salts and esters (or carboxylates) and other derivatives thereof. It can be appreciated that organic compounds include alcohols, carbonyls, and carboxylic acids, where one or more oxygens are, respectively, replaced with sulfur, selenium and/or tellurium.

The term “organophorous” generally refers to a phosphorus-containing compound containing one or more carbon-phosphorus bonds. Non-limiting examples of organophosphorus compounds include: phosphate and thiophosphyoryl esters, thioesters and amides (such as, mono-, di- and tri-phosphate esters, thioesters and amides (P(═Y)(OH)₂(XR), P(═Y)(OH)(XR)₂, and P(═Y)(XR)₃, where X can be one of oxygen, sulfur or nitrogen, Y can be one of oxygen, sulfur, selenium or tellurium and R can be a C₁-C₁₂ alkyl or aryl group), trimeyl phosphate, triethyl phosphate, tripropyl phosphate, tributyl phosphate, diazinon, phosphatidylcholine, malathion, cyclophosphamide, triphyenylphosphate and dithiophosphate); phosphonic and phosphinic acids and their esters (such as, phosphonate esters (R¹P(═O)(OR²)(OR³) and R¹R²P(═O)(OR³), where R may be hydrogen or a C₁-C₁₂ alkyl or aryl group), dimethyl phosphinic acid, diethyl phosphinic acid, dipropyl phosphinic acid, dibutyl phosphinic acid, dipentyl phosphinic acid, dihexyl phosphinic acid, methyl methylphosphonate, methyl ethylphosphonate, methyl propylphosphonate, ethyl methylphosphonate, ethyl ethylphosphonate, ethyl propylphsophonate, ethyl butylphosphonate, glyphosates, bisphosphates, and phosphinates (R₂P(═O)(OR′)); phosphine oxides (such as triethylphosphine oxide, phosphine oxides (R₃P═O) and related P—N amino compounds, phospho-imides (R₃PNR′), chalcogenides (such as, R₃PE, where E═S, Se, or Te); phosphonium salts and phosphoranes (such as, PR₄⁺, and ylides), phosphites (such as, P(OR)₃), phosphonites (such as, P(OR)₂R′), phosphinites (such as, P(OR)R′₂), phosphines (such as, PR¹R²R³, where R′, R² and R³ can be one of H, C₁-C₁₂ alkyl, C₁-C₁₂ aryl, C₃-C₈ cyclic, amino, ether, thio, and hydroxyl and where R′, R² and R³ can be the same or differ), tris(dimethylamino)phosphine, a phosonocarboxylic acid or one of its ester, carboxylate or alkali and alkaline earth phosphonocarboxylates (such as XO₂P(═O)(O₂R) where X is one or more of sodium, potassium, cesium, magnesium, calcium, strontium or barium and where R is a carboxylate derived from a C₁-C₁₂ carboxylic acid), phosphonoformate and its esters and salts, and mixtures thereof. Other examples include thiophosphate and thiophosphyoryl esters, thioesters and amides (such as, mono-, di- and tri-phosphate esters, thioesters and amides (P(═Y)(OH)₂(XR), P(═Y)(OH)(XR)₂, and P(═Y)(XR)₃, where X can be one of oxygen, sulfur or nitrogen, Y can be one of oxygen and sulfur and R can be a C₁-C₁₂ alkyl or aryl group).

The term “organophosphate” generally refers to an ester of phosphoric acid.

The term “organophosphite” generally refers to an ester of phosphorus acid.

The term “oxidizing agent” refers to one or both of a chemical substance and physical process that transfers and/or assists in removal of one or more electrons from a substance. The substance having the one or more electrons being removed is oxidized. In regards to the physical process, the physical process may removal and/or may assist in the removal of one or more electrons from the substance being oxidized. For example, the substance to be oxidized can be oxidized by electromagnetic energy when the interaction of the electromagnetic energy with the substance be oxidized is sufficient to substantially remove one or more electrons from the substance. On the other hand, the interaction of the electromagnetic energy with the substance being oxidized may not be sufficient to remove one or more electrons, but may be enough to excite electrons to higher energy state, were the electron in the excited state can be more easily removed by one or more of a chemical substance, thermal energy, or such.

The term “phosphaalkene” generally refers to a phosphorus-containing compound having the general structure R₂C═PR.

The term “phosphaalkynes” generally refers to a phosphorus-containing compound having the general structure RC≡P.

The term “phosphate compound” generally refers to phosphorus-containing compounds formed from a PO₄³⁻ (phosphate) or a related anion or group, such as OPO(OH)₂, structural unit alone or linked together by sharing oxygen atoms to form a linear chain or cyclic ring structure. Common phosphates are salts or esters of phosphoric acid or a tertiary salt of orthophosphoric acid. Non-limiting examples of phosphates are: PO₄³⁻ (phosphate); P₃O₁₀⁵⁻ (triphosphate); PₙO₃ₙ⁽ⁿ⁺²⁾⁻ (polyphosphate); P₃O₉³⁻ (cyclic trimethaphosphate); adenosine diphosphoric acid (ADPH); guanosine 5′-diphosphate 3′-dipphosphate (ppGpp); trimetaphosphate; hexametaphosphate; HPO₃²⁻ (phosphate); or one or more of their salts, acids, esters, anionic and organophosphorus forms; and mixtures thereof. Other examples include DNA backbone phosphate groups.

The term “phosphinic acid” generally refers to a phosphorus-containing compound having the general structure C—P═O(OH)₂ or C—P═O(OR)₂.

The term “phosphine oxide” generally refers to a compound have the general structure R₃P═O with formal oxidation state V. An exemplary phosphine oxide includes for triphenylphosphine oxide.

The term “phosphinate” generally refers to a phosphorus-containing compound having the general formula R₂P(═O)(OR′) or R₂P(OR)O. Exemplary phosphinates include glufosinate.

The term “phosphine” generally refers to a phosphorus-containing compound including PH₃ as a structure unit, where a hydrogen can be replaced by a carbon radical. Exemplary phosphines include trimethylphosphine and diphosphines PR¹R²R³, where R′, R² and R³ can be one of H, C₁-C₁₂ alkyl, C₁-C₁₂ aryl, C₃-C₈ cyclic, amino, ether, thio, and hydroxyl and where R′, R² and R³ can be the same or differ).

The term “phosphinite” generally refers to a phosphorus-containing compound having the general formula P(OR)R′₂ or R₂(RO)P.

The term “phosphite compound” generally refers to a phosphorus-containing compound formed from a PO₂³⁻ (phosphite) structural unit alone or linked together by sharing oxygen atoms to form a linear chain or cyclic ring structure. Common phosphites are salts or esters of phosphorus acid and include H₂P₂O₅²⁻ (pyrophosphites such as Phenolphthalein bisphosphate pyridine salt) and H₂PO₂⁻ (hypophosphite or phosphinate). Phosphite esters have the general structure P(OR)₃ with oxidation state +3. “Phosphite” compounds include not only phosphites but also phosphonites and phosphinites.

The term “phosphonate” generally refers to an ester of phosphonic acid of the general form RP(═O)(OR′)₂ or RP(RO)₂O. Exemplary phosphonates include glyphospate, biphosphonate, Sarin, dimethylmethylphosphonate, and aminophosphonate. Phosphonate esters include phosphonate esters (R¹P(═O)(OR²)(OR³) and R¹R²P(═O)(OR³), where R may be hydrogen or a C₁-C₁₂ alkyl or aryl group).

The term “phosphonic acid and esters thereof” generally refers to a phosphorus-containing compound having the general structure C—P═O(OH)₂ or C—P═O(OR)₂ and R—P═O(OH)₂. An example of a phosphonic acid ester is methylethyl phosphonate.

The term “phosphone oxide” generally refers to a phosphorus-containing compound having the general formula R₃P═O.

The term “phosphonite” generally refers to a phosphorus-containing compound having the general formula (P(OR)₂R′) or R(RO)₂P.

The term “phosphonium salt” generally refers to a phosphorus-containing compound having the general formula [PR₄⁺]X⁻ with formal oxidation state V. “X” can be any anion. Non-limiting examples of X⁻ are chloride, bromide, iodide, perchlorate, acetate, tetrifluoroborate, sulfate, nitrate, nitrite, to name a few. Exemplary phosphonium salts include is tetrakis(hydroxymethyl)phosphonium chloride, [P(CH₂OH)₄]Cl.

The term “phosphorane” generally refers to a phosphorus-containing compound having the general formula R₃PR₂.

The term “phosphono carboxylate” generally refers to a compound having a carboxylate functional group, such as XO₂P(═O)(O₂R) where X is one or more of sodium, potassium, cesium, magnesium, calcium, strontium or barium and where R is a carboxylate derived from a C₁-C₁₂ carboxylic acid).

The term “polish” refers to any process, such as filtration, to remove small (usually microscopic) particulate material or very small low concentrations of dissolved target material from water.

The terms “pore volume” and “pore size”, respectively, refer to pore volume and pore size determinations made by any suite measure method. Preferably, the pore size and pore volume are determined by any suitable Barret-Joyner-Halenda method for determining pore size and volume. Furthermore, it can be appreciated that as used herein pore size and pore diameter can used interchangeably.

“Precipitation” generally refers to the removal of a dissolved target material in the form of a target-laden rare earth composition, preferably an insoluble target-laden rare earth composition. The target-laden rare earth composition can comprise a target-laden cerium composition, a target-laden cerium (IV) composition, a target-laden cerium (III) composition, a target-laden lanthanium composition comprising a rare earth, a target-laden composition comprising a rare earth other than cerium or lanthium, or a combination thereof. Typically, the target-laden rare earth composition comprises a target-laden rare earth composition. For example, “precipitation” includes processes, such as adsorption and absorption of the phosphorus-containing target material by one or more of the cerium (IV) composition, the rare earth-containing additive, or a rare earth other than cerium (IV). The target-laden rare earth composition can comprise a +3 rare earth, such as cerium (III), lanthanum (III) or other lanthanoid having a +3 oxidation state.

The symbols “R” and “R′”, in a chemical formula, generally refer to a carbon-containing radical.

A “radical” generally refers to an atom or group of atoms that are joined together in some particular spatial structure and that commonly take part in chemical reactions as a single unit. A radical may have a net positive or negative charge or be neutral. A radical is an atom, molecule, or ion that has one or more unpaired electrons.

“Rare earth” refers to one or more of yttrium, scandium, lanthanum, cerium, praseodymium, neodymium, samarium, europium, gadolinium, terbium, dysprosium, holmium erbium, thulium, ytterbium, and lutetium. As will be appreciated, lanthanum, cerium, praseodymium, neodymium, samarium, europium, gadolinium, terbium, dysprosium, holmium erbium, thulium, ytterbium, and lutetium are known as lanthanoids.

The terms “rare earth”, “rare earth-containing composition”, “rare earth-containing additive” and “rare earth-containing particle” refer both to singular and plural forms of the terms. By way of example, the term “rare earth” refers to a single rare earth and/or combination and/or mixture of rare earths and the term “rare earth-containing composition” refers to a single composition comprising a single rare earth and/or a mixture of differing rare earth-containing compositions containing one or more rare earths and/or a single composition containing one or more rare earths. The terms “rare earth-containing additive” and “rare earth-containing particle” are additives or particles including a single composition comprising a single rare earth and/or a mixture of differing rare earth-containing compositions containing one or more rare earths and/or a single composition containing one or more rare earths. The term “processed rare earth composition” refers not only to any composition containing a rare earth other than non-compositionally altered rare earth-containing minerals. In other words, as used herein “processed rare earth-containing composition” excludes comminuted naturally occurring rare earth-containing minerals. However, as used herein “processed rare earth-containing composition” includes a rare earth-containing mineral where one or both of the chemical composition and chemical structure of the rare earth-containing portion of the mineral has been compositionally altered. More specifically, a comminuted naturally occurring bastnäsite would not be considered a processed rare earth-containing composition and/or processed rare earth-containing additive. However, a synthetically prepared bastnäsite or a rare earth-containing composition prepared by a chemical transformation of naturally occurring bastnäsite would be considered a processed rare earth-containing composition and/or processed rare earth-containing additive. The processed rare earth and/or rare-containing composition and/or additive are, in one application, not a naturally occurring mineral but synthetically manufactured. Exemplary naturally occurring rare earth-containing minerals include bastnäsite (a carbonate-fluoride mineral) and monazite. Other naturally occurring rare earth-containing minerals include aeschynite, allanite, apatite, britholite, brockite, cerite, fluorcerite, fluorite, gadolinite, parisite, stillwellite, synchisite, titanite, xenotime, zircon, and zirconolite. Exemplary uranium minerals include uraninite (UO₂), pitchblende (a mixed oxide, usually U₃O₈), brannerite (a complex oxide of uranium, rare-earths, iron and titanium), coffinite (uranium silicate), carnotite, autunite, davidite, gummite, torbernite and uranophane. In one formulation, the rare earth-containing composition is substantially free of one or more elements in Group 1, 2, 4-15, or 17 of the Periodic Table, a radioactive species, such as uranium, sulfur, selenium, tellurium, and polonium.

The term “reducing agent”, “reductant” or “reducer” refers to an element or compound that donates one or more electrons to another species or agent this is reduced. In the reducing process, the reducing agent is oxidized and the other species, which accepts the one or more electrons, is reduced.

The terminology “removal”, “remove” or “removing” includes the sorption, precipitation, conversion, detoxification, deactivation, and/or combination thereof of a target material contained in a water and/or water handling system.

The term “soluble” refers to a material that readily dissolves in a fluid, such as water or other solvent. For purposes of this disclosure, it is anticipated that the dissolution of a soluble material would necessarily occur on a time scale of minutes rather than days. For the material to be considered to be soluble, it is necessary that the material/composition has a significant solubility in the fluid such that upwards of about 5 g of the material will dissolve in about one liter of the fluid and be stable in the fluid.

The term “sorb” refers to adsorption, absorption or both adsorption and absorption.

The term “suspension” refers to a heterogeneous mixture of a solid, typically in the form of particulates dispersed in a liquid. In a suspension, the solid particulates are in the form of a discontinuous phase dispersed in a continuous liquid phase. The term “colloid” refers to a suspension comprising solid particulates that typically do not settle-out from the continuous liquid phase due to gravitational forces. A “colloid” typically generally refers to a system having finely divided particles ranging from about 10 to 10,000 angstroms in size, dispersed within a continuous medium. As used hereinafter, the terms “suspension”, “colloid” or “slurry” will be used interchangeably to refer to one or more materials dispersed and/or suspended in a continuous liquid phase. The terms “particle”, “particles”, “particulate”, and “particulates” will be used interchangeably and the use of one over the other does not connotate a chemical and/or physical difference.

The term “surface area” refers to surface area of a material and/or substance determined by any suitable surface area measurement method. Preferably, the surface area is determined by any suitable Brunauer-Emmett-Teller (BET) analysis technique for determining the specific area of a material and/or substance.

The term “thiophosphate” (or phosphorothioate) generally refers to a family of compounds and anions with the general chemical formula PS₄₋ₓO_{X}³⁻ (x=0, 1, 2, or 3). The state of protonation is usually not specified. They could be bound to as many as three protons for the neutral H₃PS₄₋ₓOₓ species. Two protons correspond to the related monoanions, and one proton for the dianions.

The term “water handling system” generally refers to any system containing, conveying, manipulating, physically transforming, chemically processing, mechanically processing, purifying, generating and/or forming the aqueous composition, treating, mixing and/or co-mingling the aqueous composition with one or more other waters and any combination thereof.

A “water handling system component” generally refers to one or more unit operations and/or pieces of equipment that process and/or treat water (such as a holding tank, reactor, purifier, treatment vessel or unit, mixing vessel or element, wash circuit, precipitation vessel, separation vessel or unit, settling tank or vessel, reservoir, pump, aerator, cooling tower, heat exchanger, valve, boiler, filtration device, solid liquid and/or gas liquid separator, nozzle, tender, and such), conduits interconnecting the unit operations and/or equipment (such as piping, hoses, channels, aqua-ducts, ditches, and such) and the water conveyed by the conduits. The water handling system components and conduits are in fluid communication.

The terms “water” and “water handling system” will be used interchangeably. That is, the term “water” may used to refer to “a water handling system” and the term “water handling system” may be used to refer to the term “water”.

The preceding is a simplified summary of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The accompanying drawings, which are incorporated in and constitute a part of the specification, illustrates embodiments of the disclosure and together with the general description of the disclosure given above and the detailed description given below, serve to explain the principles of the disclosure.

FIG. 1 depicts a water handling system and method according to an embodiment;

FIGS. 2A-2E are prior art Pourbaix or Eh-pH diagrams for phosphoric acid constructed using differing thermodynamic databases, the thermodynamic database constitutes are denoted in the respective Figs; and

FIG. 3 is a plot of arsenic capacity (mg As/g CeO₂) against various solution compositions.

### DETAILED DESCRIPTION

### General Overview

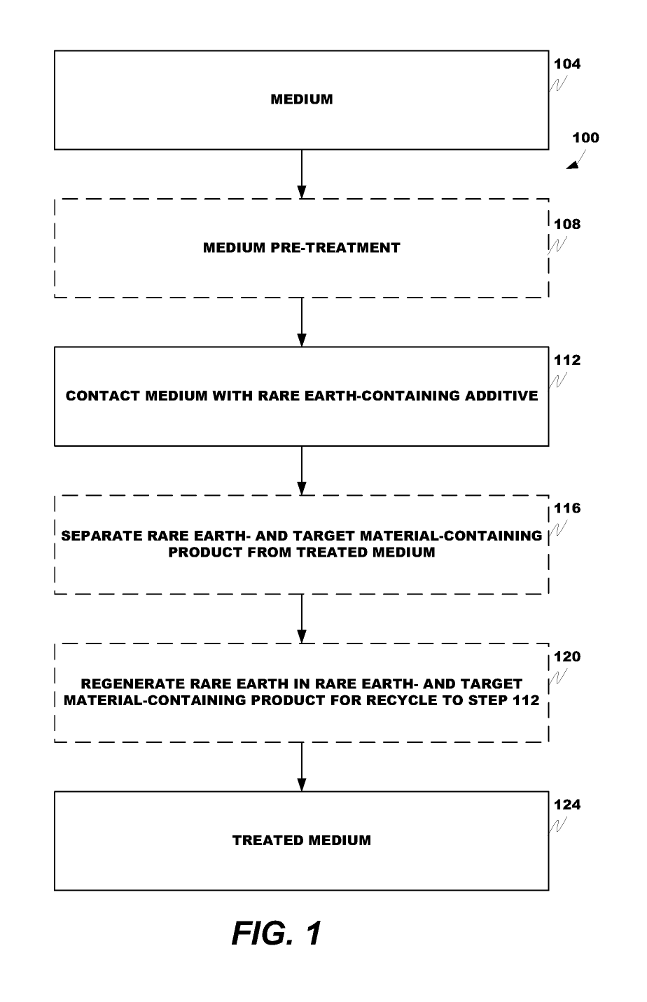

As illustrated by FIG. 1, the present disclosure is directed to removal from and/or detoxitication of water, a water-handling system or other aqueous media, of a phosphorus-containing target material. The phosphorus-containing target material may be in the form of a pollutant or contaminant. The phosphorus-containing target material is removed and/or detoxified by a rare earth-containing composition, additive or particle. Preferably, the rare earth-containing composition, additive or particle is a processed rare earth-containing additive or particle. In some embodiments, the phosphorus-containing target material is removed and/or detoxified by forming a target-laden rare earth composition. The target-laden rare earth composition comprises a rare earth and one or more of the phosphorus-containing target material or a portion of the phosphorus-containing

The phosphorus-containing target material is commonly one or more of phosphoric acid, phosphorus acid, phosphonic acid, or a salt or ester or mixture thereof.

### Rare Earth-Containing Composition, Additive and/or Particle

The rare earth-containing composition, additive and/or particles may be water-soluble, water-insoluble, a combination of water-soluble and/or water-insoluble rare earth-containing compositions, additives and/or particles, a partially water-soluble rare earth-containing composition, additive and/or particles, and/or a partially water-insoluble rare earth-containing composition, additive and/or particles.

Commonly, the rare earth-containing composition, additive and/or particles comprise cerium, in the form of a cerium-containing compound and/or a dissociated ionic form of cerium, lanthanum, in the form of a lanthanum-containing compound and/or dissociated ionic form of lanthanum, or a mixture thereof. More common rare earth-containing compositions, additives and particles are cerium (IV) oxides, cerium (III) oxides, cerium (IV) salts, cerium (III) salts, lanthanum (III) oxides, lanthanum (III) salts, or mixtures and/or combinations thereof.

The rare earth-containing composition, additive and/or particles may contain one or more rare earths, and be in any suitable form, such as a free-flowing powder, a liquid formulation, or other form. Examples of rare earth-containing compositions, additives, and particles include cerium (III) oxides, cerium (IV) oxides, ceric (IV) salts (such as ceric chloride, ceric bromide, ceric iodide, ceric sulfate, ceric nitrate, ceric chlorate, and ceric oxalate), cerium (III) salts (such as cerous chloride, cerous bromide, cerous iodide, cerous sulfate, cerous nitrate, cerous chlorate, and cerous oxalate), lanthanum (III) oxides, lanthanum (III) salts (such as lanthanum chloride, lanthanum bromide, lanthanum iodide, lanthanum chlorate, lanthanum sulfate, lanthanum oxalate, and lanthanum nitrate), and mixtures thereof.

The rare earth and/or rare earth-containing composition in the rare earth-containing additive can be rare earths in elemental, ionic or compounded forms. The rare earth and/or rare earth-containing composition can be contained in a fluid, such as water, or in the form of nanoparticles, particles larger than nanoparticles, agglomerates, or aggregates or combinations and/or mixtures thereof. The rare earth and/or rare earth-containing composition can be supported or unsupported. The rare earth and/or rare earth-containing composition can comprise one or more rare earths. The rare earths may be of the same or different valence and/or oxidation states and/or numbers. The rare earths can be a mixture of different rare earths, such as two or more of yttrium, scandium, cerium, lanthanum, praseodymium, and neodymium.

The rare earth and/or rare earth-containing composition is, in one application, a processed rare earth-containing composition and does not include, or is substantially free of, a naturally occurring and/or derived mineral. In one formulation, the rare earth and/or rare earth-containing composition is substantially free of one or more elements in Group 1, 2, 4-15, or 17 of the Periodic Table, and is substantially free of a radioactive species, such as uranium, sulfur, selenium, tellurium, and polonium.

In some formulations, the rare earth-containing composition comprises one or more rare earths. While not wanting to be limited by example, the rare earth-containing composition can comprise a first rare earth and a second rare earth. The first and second rare earths may have the same or differing atomic numbers. In some formulations, the first rare earth comprises cerium (III) and the second rare earth comprises a rare earth other than cerium (III). The rare earth other than cerium (III) can be one or more trivalent rare earths, cerium (IV), or any other rare other than trivalent cerium. For example, a mixture of rare earth-containing compositions can comprise a first rare earth having a +3 oxidation state and a second rare earth having a +4 oxidation state. In some embodiments, the first and second rare earths are the same and comprise cerium. More specifically, the first rare earth comprises cerium (III) and the second rare earth comprises cerium (IV). Preferably, the cerium is primarily in the form of a water-soluble cerium (III) salt, with the remaining cerium being present as cerium oxide, a substantially water insoluble cerium composition.

In one formulation, the cerium is primarily in the form of a dissociated cerium (III) salt, with the remaining cerium being present as cerium (IV) oxide. For rare earth-containing compositions having a mixture of +3 and +4 oxidations states commonly at least some of the rare earth has a +3 oxidation state, more commonly at least most of the rare earth has a +3 oxidation state, more commonly at least about 75 wt % of the rare earth has a +3 oxidation state, even more commonly at least about 90 wt % of the rare earth has a +3 oxidation state, and yet even more commonly at least about 98 wt % of the rare earth has a +3 oxidation state. The rare earth-containing composition commonly includes at least about 1 ppm, more commonly at least about 10 ppm, and even more commonly at least about 100 ppm cerium (IV) oxide. While in some embodiments, the rare earth-containing composition includes at least about 0.0001 wt % cerium (IV), preferably at least about 0.001 wt % cerium (IV) and even more preferably at least about 0.01 wt % cerium (IV) calculated as cerium oxide. Moreover, in some embodiments, the rare earth composition-containing commonly has at least about 20,000 ppm cerium (III), more commonly at least about 100,000 ppm cerium (III) and even more commonly at least about 250,000 ppm cerium (III).

In some formulations, the molar ratio of cerium (III) to cerium (IV) is about 1 to about 1×10⁻⁶, more commonly is about 1 to about 1×10⁻⁵, even more commonly is about 1 to about 1×10⁻⁴, yet even more commonly is about 1 to about 1×10⁻³, still yet even more commonly is about 1 to about 1×10⁻², still yet even more commonly is about 1 to about 1×10⁻¹, or still yet even more commonly is about 1 to about 1. Moreover, in some formulations the molar ratio of cerium (IV) to cerium (III) is about 1 to about 1×10⁻⁶, more commonly is about 1 to about 1×10⁻⁵, even more commonly is about 1 to about 1×10⁻⁴, yet even more commonly is about 1 to about 1×10⁻³, still yet even more commonly is about 1 to about 1×10⁻², still yet even more commonly is about 1 to about 1×10⁻¹, or still yet even more commonly is about 1 to about 1. Further, these molar ratios apply for any combinations of soluble and insoluble forms of Ce (III) and soluble and insoluble forms of Ce (IV).

In one formulation, the cerium is primarily in the form of a dissociated cerium (III) salt, with the remaining cerium being present as cerium (IV) oxide. For rare earth-containing compositions having a mixture of +3 and +4 oxidations states commonly at least some of the rare earth has a +3 oxidation sate, more commonly at least most of the rare earth has a +3 oxidation state, more commonly at least about 75 wt % of the rare earth has a +3 oxidation state, even more commonly at least about 90 wt % of the rare earth has a +3 oxidation state, and yet even more commonly at least about 98 wt % of the rare earth has a +3 oxidation state. The rare earth-containing composition commonly includes at least about 1 ppm, more commonly at least about 10 ppm, and even more commonly at least about 100 ppm cerium (IV) oxide. While in some embodiments, the rare earth-containing composition includes at least about 0.0001 wt % cerium (IV), preferably at least about 0.001 wt % cerium (IV) and even more preferably at least about 0.01 wt % cerium (IV) calculated as cerium oxide. Moreover, in some embodiments, the rare earth composition-containing commonly has at least about 20,000 ppm cerium (III), more commonly at least about 100,000 ppm cerium (III) and even more commonly at least about 250,000 ppm cerium (III).

In some formulations, the molar ratio of cerium (III) to cerium (IV) is about 1 to about 1×10⁻⁶, more commonly is about 1 to about 1×10⁻⁵, even more commonly is about 1 to about 1×10⁻⁴, yet even more commonly is about 1 to about 1×10⁻³, still yet even more commonly is about 1 to about 1×10⁻², still yet even more commonly is about 1 to about 1×10⁻¹, or still yet even more commonly is about 1 to about 1. Moreover, in some formulations the molar ratio of cerium (IV) to cerium (III) is about 1 to about 1×10⁻⁶, more commonly is about 1 to about 1×10⁻⁵, even more commonly is about 1 to about 1×10⁻⁴, yet even more commonly is about 1 to about 1×10⁻³, still yet even more commonly is about 1 to about 1×10⁻², still yet even more commonly is about 1 to about 1×10⁻¹, or still yet even more commonly is about 1 to about 1. Further, these molar ratios apply for any combinations of soluble and insoluble forms of Ce(III) and soluble and insoluble forms of Ce(IV).

Having a mixture of +3 and +4 cerium, preferably in the form of a dissociated cerium (III) salt and a cerium (IV) composition, can be advantageous. Preferred, non-limiting examples of cerium (IV) compositions are cerium (IV) dioxide, cerium (IV) oxide, cerium (IV) oxyhydroxide, cerium (IV) hydroxide, and hydrous cerium (IV) oxide. For example, having dissociated cerium (III) provides for the opportunity to take advantage of cerium (III) solution sorption and/or precipitation chemistries, such as, but not limited to, the formation of insoluble cerium (III) oxyanion compositions. Furthermore, having a cerium (IV) composition presents, provides for the opportunity to take advantage of sorption and oxidation/reduction chemistries of cerium (IV), such as, the strong interaction of cerium (IV) with compositions such as phosphorus-containing target materials having multiple oxidation states. For example, common oxidation states of phosphorus are phosphours (II), phosphorus (III) and phosphours (V). More specifically, cerium (IV) can oxidize phosphorus-containing target materials having a phosphorus oxidation state of (II) or (III) to phosphorus-containing target materials having a phosphorus oxidation state of (V). Commonly, cerium (IV) is also referred to as cerium (+4) and/or ceric.

In one formulation, the rare earth composition comprises a water-soluble rare earth composition having a +3 oxidation state. Non-limiting examples of suitable water-soluble rare earth compositions include rare earth chlorides, rare earth bromides, rare earth iodides, rare earth astatides, rare earth nitrates, rare earth sulfates, rare earth oxalates, rare earth perchlorates, rare earth carbonates, and mixtures thereof. In one formulation, the rare earth-containing additive includes water-soluble cerium (III) and lanthanum (III) compositions. In some applications, the water-soluble cerium composition comprises cerium (III) chloride, CeCl₃. Commonly, cerium (III) is also referred to as cerium (+3) and/or cerous.

More preferably, the rare earth composition comprises a water-soluble cerium +3 composition. Non-limiting examples of suitable water-soluble cerium +3 compositions are cerium (III) chloride, cerium (III) nitrate, cerium (III) sulfate, cerium (III) oxalate, and a mixture thereof.

In some formulations, the water-soluble cerium (III) composition may comprise, in addition to cerium, one or more other water-soluble rare earths. The rare earths other than cerium include yttrium, scandium, lanthanum, praseodymium, neodymium, samarium, europium, gadolinium, terbium, dysprosium, holmium, erbium, thulium, ytterbium, and lutetium. The other rare earths may and may not be water-soluble.

In some formulations, the water-soluble cerium-containing additive contains water-soluble cerium (III) and one or more other water-soluble trivalent rare earths (such as, but not limited to, one or more of lanthanum, neodymium, praseodymium and samarium). The molar ratio of cerium (III) to the other trivalent rare earths is commonly at least about 1:1, more commonly at least about 10:1, more commonly at least about 15:1, more commonly at least about 20:1, more commonly at least about 25:1, more commonly at least about 30:1, more commonly at least about 35:1, more commonly at least about 40:1, more commonly at least about 45:1, and more commonly at least about 50:1.

In some formulations, the water-soluble cerium-containing additive contains cerium (III) and one or more of water-soluble lanthanum, neodymium, praseodymium and samarium. The water-soluble rare earth-containing additive commonly includes at least about 0.01 wt % of one or more of lanthanum, neodymium, praseodymium and samarium. The water-soluble rare earth-containing additive commonly has on a dry basis no more than about 10 wt % La, more commonly no more than about 9 wt % La, even more commonly no more than about 8 wt % even more commonly no more than about 7 wt % La, even more commonly no more than about 6 wt % La, even more commonly no more than about 5 wt % La, even more commonly no more than about 4 wt % La, even more commonly no more than about 3 wt % La, even more commonly no more than about 2 wt % La, even more commonly no more than about 1 wt % La, even more commonly no more than about 0.5 wt % La, and even more commonly no more than about 0.1 wt % La. The water-soluble rare earth-containing additive commonly has on a dry basis no more than about 8 wt % Nd, more commonly no more than about 7 wt % Nd, even more commonly no more than about 6 wt % Nd, even more commonly no more than about 5 wt % Nd, even more commonly no more than about 4 wt % Nd, even more commonly no more than about 3 wt % Nd, even more commonly no more than about 2 wt % Nd, even more commonly no more than about 1 wt % Nd, even more commonly no more than about 0.5 wt % Nd, and even more commonly no more than about 0.1 wt % Nd. The water-soluble rare earth-containing additive commonly has on a dry basis no more than about 5 wt % Pr, more commonly no more than about 4 wt % Pr, even more commonly no more than about 3 wt % Pr, even more commonly no more than about 2.5 wt % Pr, even more commonly no more than about 2.0 wt % Pr, even more commonly no more than about 1.5 wt % Pr, even more commonly no more than about 1.0 wt % Pr, even more commonly no more than about 0.5 wt % Pr, even more commonly no more than about 0.4 wt % Pr, even more commonly no more than about 0.3 wt % Pr, even more commonly no more than about 0.2 wt % Pr, and even more commonly no more than about 0.1 wt % Pr. The water-soluble rare earth-containing additive commonly has on a dry basis no more than about 3 wt % Sm, more commonly no more than about 2.5 wt % Sm, even more commonly no more than about 2.0 wt % Sm, even more commonly no more than about 1.5 wt % Sm, even more commonly no more than about 1.0 wt % Sm, even more commonly no more than about 0.5 wt % Sm, even more commonly no more than about 0.4 wt % Sm, even more commonly no more than about 0.3 wt % Sm, even more commonly no more than about 13.2 wt % Sm, even more commonly no more than about 0.1 wt % Sm, even more commonly no more than about 0.05 wt % Sm, and even more commonly no more than about 0.01 wt % Sm.

In some formulations, the water-soluble cerium-containing additive contains water-soluble cerium (III) and one or more other water-soluble trivalent rare earths (such as one or more of lanthanum, neodymium, praseodymium and samarium). The molar ratio of cerium (III) to the other trivalent rare earths is commonly at least about 1:1, more commonly at least about 10:1, more commonly at least about 15:1, more commonly at least about 20:1, more commonly at least about 25:1, more commonly at least about 30:1, more commonly at least about 35:1, more commonly at least about 40:1, more commonly at least about 45:1, and more commonly at least about 50:1.

In one formulation, the rare earth-containing additive consists essentially of a water-soluble cerium (III) salt, such as a cerium (III) chloride, cerium (III) bromide, cerium (III) iodide, cerium (III) astatide, cerium perhalogenates, cerium (III) carbonate, cerium (III) nitrate, cerium (III) sulfate, cerium (III) oxalate and mixtures thereof. The rare earth in this formulation commonly is primarily cerium (III), more commonly at least about 75 mole % of the rare earth content of the rare earth-containing additive is cerium (III), that is no more than about 25 mole % of the rare earth content of the rare earth-containing additive comprises rare earths other than cerium (III). Even more commonly, the rare earth in this formulation commonly is primarily at least about 80 mole % cerium (III), yet even more commonly at least about 85 mole % cerium (III), still yet even more commonly at least about 90 mole % cerium (III), and yet still even more commonly at least about 95 mole % cerium (III).

The rare earth composition may comprise a water-insoluble composition, such as a water-insoluble rare earth oxide, oxyhydroxide, and/or hydrous oxide. The insoluble rare earth composition may be in the form of a dispersion, suspension or slurry of rare earth particulates. The rare earth particulates can have an average particle size ranging from the sub-micron, to micron or greater than micron. The insoluble rare earth composition may have a surface area of at least about 1 m²/g. Commonly, the insoluble rare earth has a surface area of at least about 70 m²/g. In another formulation, the insoluble rare earth composition may have a surface area from about 25 m²/g to about 500 m²/g.

In some formulations, the rare earth composition may be agglomerated. Commonly, the rare earth composition may be in the form of an agglomerate, the agglomerate comprising a polymeric binder and the rare earth composition.

In one formulation, the rare earth-containing additive comprises a rare earth and/or rare earth-containing composition comprising at least some water-insoluble cerium (IV) and water-soluble cerium (III) and/or lanthanum (III). The rare earth and/or rare earth-containing composition comprise at least some water-soluble cerium (III), typically in the form of water-soluble cerium (III) salt. Commonly, the rare earth-containing additive comprises more than about 1 wt % of a water-soluble cerium (III) composition, more commonly more than about 5 wt % of a water-soluble cerium (III) composition, even more commonly more than about 10 wt % of a water-soluble cerium (III) composition, yet even more commonly more than about 20 wt % of a water-soluble cerium (III) composition, still yet even more commonly more than about 30 wt % of a water-soluble cerium (III) composition, or still yet even more commonly more than about 40 wt % of a water-soluble cerium (III) composition.

In accordance with some formulations, the rare earth-containing additive typically comprises more than about 50 wt % of a water-soluble cerium (III) composition, more typically the rare earth-containing additive comprises more than about 60 wt % of a water-soluble cerium (III) composition, even more typically the rare earth-containing additive comprises more than about 65 wt % of a water-soluble cerium (III) composition, yet even more typically the rare earth-containing additive comprises more than about 70 wt % of a water-soluble cerium (III) composition, still yet even more typically the rare earth-containing additive comprises more than about 75 wt % of a water-soluble cerium (III) composition, still yet even more typically the rare earth-containing additive comprises more than about 80 wt % of a water-soluble cerium (III) composition, still yet even more typically the rare earth-containing additive comprises more than about 85 wt % of a water-soluble cerium (III) composition, still yet even more typically the rare earth-containing additive comprises more than about 90 wt % of a water-soluble cerium (III) composition, still yet even more typically the rare earth-containing additive comprises more than about 95 wt % of a water-soluble cerium (III) composition, still yet even more typically the rare earth-containing additive comprises more than about 98 wt % of a water-soluble cerium (III) composition, still yet even more typically the rare earth-containing additive comprises more than about 99 wt % of a water-soluble cerium (III) composition, or yet still eve more typically comprises about 100 wt % of a water-soluble cerium (III) composition.

In some formulations, the rare earth-containing additive comprises one or more nitrogen-containing materials. The one or more nitrogen-containing materials, commonly, comprise one or more of ammonia, an ammonium-containing composition, a primary amine, a secondary amine, a tertiary amine, an amide, a cyclic amine, a cyclic amide, a polycyclic amine, a polycyclic amide, and combinations thereof. The nitrogen-containing materials are typically less than about 1 ppm, less than about 5 ppm, less than about 10 ppm, less than about 25 ppm, less than about 50 ppm, less about 100 ppm, less than about 200 ppm, less than about 500 ppm, less than about 750 ppm or less than about 1000 ppm of the water-soluble rare earth-containing additive. Commonly, the rare earth-containing additive comprises a water-soluble cerium (III) and/or lanthanum (III) composition. More commonly, the rare earth-containing additive comprises cerium (III) chloride. The rare earth-containing additive is typically dissolved in a liquid. The liquid is the rare earth-containing additive is dissolved in is preferably water.

In some formulations, the rare earth-containing additive is in the form of one or more of an aqueous solution containing substantially dissociated, dissolved forms of the rare earths and/or rare earth-containing compositions; free flowing granules, powder, particles, and/or particulates of rare earths and/or rare earth-containing compositions containing at least some water-soluble cerium (III); free flowing aggregated granules, powder, particles, and/or particulates of rare earths and/or rare earth-containing compositions substantially free of a binder and containing at least some water-soluble cerium (III); free flowing agglomerated granules, powder, particles, and/or particulates comprising a binder and rare earths and/or rare earth-containing compositions one or both of in an aggregated and non-aggregated form and containing at least some water-soluble cerium (III); rare earths and/or rare earth-containing compositions containing at least some water-soluble cerium (III) and supported on substrate; and combinations thereof.

Regarding particulate forms of rare earth-containing compositions, the particles, in one formulation, have a particle size may be from about 1 nanometer to about 1000 nanometers. In another embodiment the particles may have a particle size less than about 1 nanometer. In yet another embodiment the particles may have a particle size from about 1 micrometer to about 1,000 micrometers.

Regarding rare earths and/or rare earth-containing compositions supported on a substrate, suitable substrates can include porous and fluid permeable solids having a desired shape and physical dimensions. The substrate, for example, can be a sintered ceramic, sintered metal, micro-porous carbon, glass fiber, cellulosic fiber, alumina, gamma-alumina, activated alumina, acidified alumina, a metal oxide containing labile anions, crystalline alumino-silicate such as a zeolite, amorphous silica-alumina, ion exchange resin, clay, ferric sulfate, porous ceramic, and the like. Such substrates can be in the form of mesh, such as screens, tubes, honeycomb structures, monoliths, and blocks of various shapes, including cylinders and toxoids. The structure of the substrate will vary depending on the application. Suitable structural forms of the substrate can include a woven substrate, non-woven substrate, porous membrane, filter, fabric, textile, or other fluid permeable structure. The rare earth-containing additive can be incorporated into or coated onto a filter block or monolith for use as a filter, such as a cross-flow type filter. The rare earth and/or rare earth-containing additive can be in the form of particles coated on to or incorporated in the substrate. In some configurations, the rare earth and/or rare earth-containing additive can be ionically substituted for cations in the substrate. Typically, the rare earth-coated substrate comprises at least about 0.1% by weight, more typically 1% by weight, more typically at least about 5% by weight, more typically at least about 10% by weight, more typically at least about 15% by weight, more typically at least about 20% by weight, more typically at least about 25% by weight, more typically at least about 30% by weight, more typically at least about 35% by weight, more typically at least about 40% by weight, more typically at least about 45% by weight, and more typically at least about 50% by weight rare earth and/or rare earth-containing composition. Typically, the rare earth-coated substrate includes no more than about 95% by weight, more typically no more than about 90% by weight, more typically no more than about 85% by weight, more typically no more than about 80% by weight, more typically no more than about 75% by weight, more typically no more than about 70% by weight, and even more typically no more than about 65% by weight rare earth and/or rare earth-containing composition.

In some formulations, the rare earth-containing additive includes a rare earth-containing composition supported on, coated on, or incorporated into a substrate, preferably the rare earth-containing composition is in the form of particulates. The rare earth-containing particulates can, for example, be supported or coated on the substrate with or without a binder. The binder may be any suitable binder, such as those set forth herein.

Further regarding formulations comprising the rare earth-containing additive comprising rare earth-containing granules, powder, particles, and/or particulates agglomerated and/or aggregated together with or without a binder, such formulations commonly have a mean, median, or P₉₀ particle size of at least about 1 μm, more commonly at least about 5 μm, more commonly at least about 10 μm, still more commonly at least about 25 μm. In some formulations, the rare earth-containing agglomerates or aggregates have a mean, median, or P₉₀ particle size distribution from about 100 to about 5,000 microns; a mean, median, or P₉₀ particle size distribution from about 200 to about 2,500 microns; a mean, median, or P₉₀ particle size distribution from about 250 to about 2,500 microns; or a mean, median, or P₉₀ particle size distribution from about 300 to about 500 microns. In other formulations, the agglomerates and/or aggregates can have a mean, median, or P₉₀ particle size distribution of at least about 100 nm, specifically at least about 250 nm, more specifically at least about 500 nm, even more specifically at least about 1 μm and yet even more specifically at least about 0.5 nm, the mean, median, or P₉₀ particle size distribution of the agglomerates and/or aggregates can be up to about 1 micron or more. Moreover, the rare earth-containing particulates, individually and/or in the form of agglomerates and/or aggregates, can have in some cases a surface area of at least about 5 m²/g, in other cases at least about 10 m²/g, in other cases at least about 70 m²/g, in yet other cases at least about 85 m²/g, in still yet other cases at least about 100 m²/g, in still yet other cases at least about 115 m²/g, in still yet other cases at least about 125 m²/g, in still yet other cases at least about 150 m²/g, in still yet other cases at least 300 m²/g, and in still yet other cases at least about 400 m²/g. In some configurations, the rare earth-containing particulates, individually and/or in the form of agglomerates or aggregates commonly can have a surface area from about 50 to about 500 m²/g, or more commonly from about 110 to about 250 m²/g. Commonly, the rare earth-containing agglomerate includes more than 10.01 wt %, more commonly more than about 85 wt %, even more commonly more than about 90 wt %, yet even more commonly more than about 92 wt % and still yet even more commonly from about 95 to about 96.5 wt % rare earth-containing particulates, with the balance being primarily the binder. Stated another way, the binder can be less than about 15% by weight of the agglomerate, in some cases less than about 10% by weight, in still other cases less than about 8% by weight, in still other cases less than about 5% by weight, and in still other cases less than about 3.5% by weight of the agglomerate. In some formulations, the rare earth-containing particulates are in the form of powder and have aggregated nano-crystalline domains. The binder can include one or more polymers selected from the group consisting of thermosetting polymers, thermoplastic polymers, elastomeric polymers, cellulosic polymers and glasses. Preferably, the binder comprises a fluorocarbon-containing polymer and/or an acrylic-polymer.

In one embodiment, the rare earth-containing composition is in the form of a colloid, suspension, or slurry of particulates. The particulates commonly can have a mean, median and/or P₉₀ particle size of less than about 1 nanometer, more commonly a mean, median and/or P₉₀ particle size from about 1 nanometer to about 1,000 nanometers, even more commonly a mean, median and/or P₉₀ particle size from about 1 micron to about 1,000 microns, or yet even more commonly a mean, median and/or P₉₀ particle size of at least about 1,000 microns. Preferably, the particulates have a mean, median and/or P₉₀ particle size from about 0.1 to about 1,000 nm, more preferably from about 0.1 to about 500 nm. Even more preferably, the cerium (IV) particulates have a mean, median and/or P₉₀ particle size from about 0.2 to about 100 nm.

In some embodiments, the particulates may have a mean and/or median surface area of at least about 1 m²/g, preferably a mean and/or median surface area of at least about 70 m²/g. In other embodiments, the particulates may preferably have a mean and/or median surface area from about 25 m²/g to about 500 m²/g and more preferably, a mean and/or median surface area of about 100 to about 250 m²/g. In some embodiments, the particulates may be in the form of one or more of a granule, crystal, crystallite, and particle.

In one application, the particulates comprise cerium (IV), typically as cerium (IV) oxide. The weight percent (wt %) cerium (IV) content based on the total rare earth content of the cerium (IV) particulates typically is at least about 50 wt % cerium (IV), more typically at least about 60 wt % cerium (IV), even more typically at least about 70 wt % cerium (IV), yet even more typically at least about 75 wt % cerium (IV), still yet even more typically at least about 80 wt % cerium (IV), still yet even more typically at least about 85 wt % cerium (IV), still yet even more typically at least about 90 wt % cerium (IV), still yet even more typically at least about 95 wt % cerium (IV), and even more typically at least about 99 wt % cerium (IV). Preferably, the cerium (IV) particulate is substantially devoid of rare earths other than cerium (IV). More preferably, the weight percent (wt %) cerium (IV) content based on the total rare earth content of the cerium (IV) particulates is about 100 wt % cerium (IV) and comprises one or more of cerium (IV) oxide, cerium (IV) hydroxide, cerium (IV) oxyhydroxyl, cerium (IV) hydrous oxide, cerium (IV) hydrous oxyhydroxyl, CeO₂, and/or Ce(IV)(O)_{w}(OH)ₓ(OH)_{y}.zH₂O, where w, x, y and can be zero or a positive, real number.

### The Medium (or Media) 104

The medium (or media) 104 can be any fluid stream. The fluid stream may be derived from any source containing one or more phosphorus-containing target materials. Preferably, the medium (or media) 104 is derived from any aqueous source containing one or more phosphorus-containing target materials. Non-limiting examples of suitable medium (or media) 104 are recreational waters, municipal waters (such as, sewage, waste, agricultural, or ground waters), industrial (such as cooling, boiler, or process waters), wastewaters, well waters, septic waters, drinking waters, naturally occurring waters, (such as a lake, pond, reservoir, river, or stream), and other waters and/or aqueous process streams.

Non-limiting examples of recreational waters are swimming pool waters, brine pool waters, therapy pool waters, diving pool waters, sauna waters, spa waters, and hot tub waters. Non-limiting examples of municipal waters are drinking waters, waters for irrigation, well waters, waters for agricultural use, waters for architectural use, reflective pool waters, water-fountain waters, water-wall waters, use, non-potable waters for municipal use and other non-potable municipal waters. Wastewaters include without limitation, municipal and/or agricultural run-off waters, septic waters, waters formed and/or generated during an industrial and/or manufacturing process, waters formed and/or generated by a medical facility, waters associated with mining, mineral production, recovery and/or processing (including petroleum), evaporation pound waters, and non-potable disposal waters. Well waters include without limitation waters produced from a subsurface well for the purpose of human consumption, agricultural use (including consumption by a animal, irrigation of crops or consumption by domesticated farm animals), mineral-containing waters, waters associated with mining and petroleum production. Non-limiting examples of naturally occurring waters include associated with rains, storms, streams, rivers, lakes, aquifers, estuaries, lagoons, and such.

The medium (or media) 104 is typically obtained from one or more of the above sources and processed, conveyed and/or manipulated by a water handling system. The medium (or media) 104 can be primarily the water in a water handling system.

The water handling system components and configuration can vary depending on the treatment process, water, and water source. While not wanting to limited by example, municipal and/or wastewater handling systems typically one or more of the following process units: clarifying, disinfecting, coagulating, flocculating, aerating, filtering, separating solids and liquids, digesting, and polishing. The number and ordering of the process units can vary. Furthermore, some process units may occur two or more times within a water handling system. It can be appreciated that the one or more process units are in fluid communication.

The water handling system may or may not have a clarifier. Some water handling systems may have more than one clarifier, such as primary and final clarifiers. Clarifiers typically reduce cloudiness of the water by removing biological matter (such as bacteria and/or algae), suspended and/or dispersed chemicals and/or particulates from the water. Commonly a clarification process occurs before and/or after a filtration process.

The water handling system may or may not contain a filtering process. Typically, the water handling system contains at least one filtering process. Non-limiting examples of common filtering processes include without limitation screen filtration, trickling filtration, particulate filtration, sand filtration, macro-filtration, micro-filtration, ultra-filtration, nano-filtration, reverse osmosis, carbon/activated carbon filtration, dual media filtration, gravity filtration and combinations thereof. Commonly a filtration process occurs before and/or after a disinfection process. For example, a filtration process to remove solid debris, such as solid organic matter and grit from the water typically precedes the disinfection process. In some embodiments, a filtration process, such as an activated carbon and/or sand filtrations follows the disinfection process. The post-disinfection filtration process removes at least some of the chemical disinfectant remaining in the treated water.

The water handling system may or may not include a disinfection process. The disinfection process may include without limitation treating the aqueous stream and/or water with one or more of fluorine, fluorination, chlorine, chlorination, bromine, bromination, iodine, iodination, ozone, ozonation, electromagnetic irradiation, ultra-violet light, gama rays, electrolysis, chlorine dioxide, hypochlorite, heat, ultrasound, trichloroisocyanuric acid, soaps/detergents, alcohols, bromine chloride (BrCl), cupric ion (Cu²⁺), silver, silver ion (Ag⁺), permanganate, phenols, and combinations thereof. Preferably, the water handling system contains a single disinfection process, more preferably the water handling system contains two or more disinfection processes. Disinfection processes are typically provided to one of at least remove, kill and/or detoxify pathogenic material contained in the water. Typically, the pathogenic material comprises biological contaminants, in particular biological contaminants comprising phosphorus-containing target materials. In some embodiments, the disinfection process converts the phosphorus-containing target material into a form of the phosphorus-containing target material that can be removed and/or detoxified by the rare earth-containing composition, additive and/or particle or particulate.

The water handling system may or may not include coagulation. The water handling system may contain one or more coagulation processes. Typically, the coagulation process includes adding a flocculent to the water in the water handling system. Typical flocculants include aluminum sulfate, polyelectrolytes, polymers, lime and ferric chloride. The flocculent aggregates the particulate matter suspended and/or dispersed in the water, the aggregated particulate matter forms a coagulum. The coagulation process may or may not include separating the coagulum from the liquid phase. In some embodiments, coagulation may comprise part, or all, the entire clarification process. In other embodiments, the coagulation process is separate and distinct from the clarification process. Typically, the coagulation process occurs before the disinfection process.

The water handling system may or may not include aeration. Within the water handing system, aeration comprises passing a stream of air and/or molecular oxygen through the water contained in the water handling system. The aeration process promotes oxidation of contaminants contained in the water being processed by the water handling system, preferably the aeration promotes the oxidation of biological contaminates, such as phosphorus-containing biological contaminates. In some embodiments, the aeration process converts the phosphorus-containing target material into a form of the phosphorus-containing target material that can be removed and/or detoxified by the rare earth-containing composition, additive and/or particle or particulate. The water handling system may contain one or more aeration processes. Typically, the disinfection process occurs after the aeration process.

The water handling system may or may not have one or more of a heater, a cooler, and a heat exchanger to heat and/or cool the water being processed by the water handling system. The heater may be any method suitable for heating the water. Non-limiting examples of suitable heating processes are solar heating systems, electromagnetic heating systems (such as, induction heating, microwave heating and infrared), immersion heaters, and thermal transfer heating systems (such as, combustion, stream, hot oil, and such, where the thermal heating source has a higher temperature than the water and transfers heat to the water to increase the temperature of the water). The heat exchanger can be any process that transfers thermal energy to or from the water. The heat exchanger can remove thermal energy from the water to cool and/or decrease the temperature of the water. Or, the heat exchanger can transfer thermal energy to the water to heat and/or increase the temperature of the water. The cooler may be any method suitable for cooling the water. Non-limiting examples of suitable cooling process are refrigeration process, evaporative coolers, and thermal transfer cooling systems (such as, chillers and such where the thermal (cooling) source has a lower temperature than the water and removes heat from the water to decrease the temperature of the water). Any of the clarification, disinfection, coagulation, aeration, filtration, sludge treatment, digestion, nutrient control, solid/liquid separation, and/or polisher processes may further include before, after and/or during one or both of a heating and cooling process. It can be appreciated that a heat exchanger typically includes at least one of heating and cooling process.

The water handling system may or may not include a digestion process. Typically, the digestion process is one of an anaerobic or aerobic digestion process. In some configurations, the digestion process may include one of an anaerobic or aerobic digestion process followed by the other of the anaerobic or aerobic digestion processes. For example, one such configuration can be an aerobic digestion process followed by an anaerobic digestion process. Commonly, the digestion process comprises microorganisms that breakdown the biodegradable material contained in the water. In some embodiments, the biodegradable material includes a phosphorus-containing target material. Furthermore, the digestion process converts the phosphorus-containing target material into a form of the phosphorus-containing target material that can be removed and/or detoxified by the rare earth-containing composition, additive and/or particle or particulate. The anaerobic digestion of biodegradable material proceeds in the absence of oxygen, while the aerobic digestion of biodegradable material proceeds in the presence of oxygen. In some water handling systems the digestion process is typically referred to as biological stage/digester or biological treatment stage/digester. Moreover, in some systems the disinfection process comprises a digestion process.

The water handling system may or may not include a nutrient control process. Furthermore, the water handling system may include one or more nutrient control processes. The nutrient control process typically includes nitrogen and/or phosphorus control. Moreover, nitrogen control commonly may include nitrifying bacteria. Typically, phosphorus control refers to biological phosphorus control, preferably controlling phosphorus that can be used as a nutrient for algae. Nutrient control typically includes processes associated with control of oxygen demand substances, which include in addition to nutrients, pathogens, and inorganic and synthetic organic compositions. The nutrient control process can occur before or after the disinfection process. In some embodiments, the nutrient control converts the phosphorus-containing target material into a form of the phosphorus-containing target material that can be removed and/or detoxified by the rare earth-containing composition, additive and/or particle or particulate.

The water handling system may or may not include a solid/liquid separation process. Preferably, the water handling system includes one or more solid/liquid separation processes. The solid/liquid separation process can comprise any process for separating a solid phase from a liquid phase, such as water. Non-limiting examples of suitable solid liquid separation processes are clarification (including trickling filtration), filtration (as described above), vacuum and/or pressure filtration, cyclone (including hydrocyclones), floatation, sedimentation (including gravity sedimentation), coagulation (as described above), sedimentation (including, but not limited to grit chambers), and combinations thereof.

The water handling system may or may not include a polisher. The polishing process can include one or more of removing fine particulates from the water, an ion-exchange process to soften the water, an adjustment to the pH value of the water, or a combination thereof. Typically, the polishing process is after the disinfection step.

While the water handling system typically includes one or more of a clarifying, disinfecting, coagulating, aerating, filtering, separating solids and liquids, digesting, and polishing processes, the water handling system may further include additional processing equipment. The additional processing equipment includes without limitation holding tanks, reactors, purifiers, treatment vessels or units, mixing vessels or elements, wash circuits, precipitation vessels, separation vessels or units, settling tanks or vessels, reservoirs, pumps, cooling towers, heat exchangers, valves, boilers, gas liquid separators, nozzles, tenders, and such. Furthermore, the water handling system includes conduit(s) interconnecting the unit operations and/or additional processing equipment. The conduits include without limitation piping, hoses, channels, aqua-ducts, ditches, and such. The water is conveyed to and from the unit operations and/or additional processing equipment by the conduit(s). Moreover, each unit operations and/or additional processing equipment is in fluid communication with the other unit operations and/or additional processing equipment by the conduits.

In one configuration, the water handling system includes sludge and Biological Oxygen Demand (“BOD”) removal from an aqueous medium (or media) 104) by gravity settling techniques (by a settling tank), to form a first intermediate treated medium, clarification (by a clarifier vessel) of the first intermediate treated medium to form a second intermediate treated medium and remove more finely sized solids and BOD, digestion of the second intermediate treated medium to form a digested third intermediate treated medium, clarification (by a further clarifier vessel) of the digested third intermediate treated medium to form a fourth intermediate treated medium, and disinfection of the fourth intermediate treated medium to form the treated medium 124. The treated medium 124 can be further subjected to tertiary treatment to remove dissolved substances, such as colorants, metals, organic chemicals, and microorganism nutrients, particularly phosphorus and nitrogen. Tertiary treatment can include clarification, anaerobic, anoxic, and/or aerobic biological nutrient removal, disinfection, dissolved air flotation, fermentation, digestion, and the like. The ordering of the steps is not critical and may be changed, depending on the application. The rare earth-containing additive can be added to any of the first intermediate treated medium, second intermediate treated medium, third intermediate treated medium, and/or fourth intermediate treated medium and/or in any of the clarification, digestion, or disinfection stages and/or in any tertiary treatment stage of inter-stage effluent. Because the rare earth-containing additive can be an antimicrobial agent, it is more common for the rare earth-containing additive to be added downstream of digestion to avoid interference with bacterial digestion. Because the rare earth-containing additive can be an antimicrobial agent, one process configuration uses the rare earth-containing additive for both phosphate removal and microcrobial removal. In this configuration, other antimicrobial agents may not be employed. In one configuration, the process steps can change the relative concentrations and therefore ratios of reactive phosphate (“RP”) and non-reactive phosphate (“NRP”), particularly digestion (due to aeration and/or microbial activity) and disinfection. Typically, the process converts a portion of NRP to RP, thereby increasing the proportion of total phosphates (which includes both RP and NRP) that is RP. In other applications, the process converts a portion of RP to NRP, thereby increasing the proportion of total phosphates that is NRP.

### The Phosphorus-Containing Target Material

The aqueous medium that is treated by the rare earth-containing composition, additive and/or particles may contain one or more phosphorus-containing target materials. The one or more phosphorus-containing target materials may include one or both of inorganic and organic phosphorus-containing target materials. Inorganic phosphorus-containing target materials metals include without limitation inorganic phosphate compounds, phosphite compounds, phosphorus oxyhalide (e.g., phosphorus oxychloride), phosphorus thiohalide (e.g., phosphorus thiochloride), phosphorus selenohalide (e.g., phosphorus selenochloride), phosphorus trihalide (e.g., phosphorus trichloride), phosphorus pentahalide (e.g., phosphorus pentachloride), phosphoric acid, and phosphorus acid and salts thereof (e.g., cyclic phosphate and phosphite salts). Organic phosphorus-containing target materials include without limitation organophosphorus compounds (such as organophosphates (or organic phosphate compounds), organophosphites (or organic phosphite compounds), and organophosphines, (or organic phosphines)). Examples of organophosphorus compounds include chalcogenides, diphosphenes, phosoamides, phosphaalkenes, phosphaalkynes, phosphine oxides, phosphinates, phosphines, phosphinites, phosphonates (e.g., o-alkyl phosphonohalogenates (such as alkyl phosphonofluoridates (such as sarin or isopropyl methylphosphonofluoridate), o-alkyl, s-2-dialkyl aminoethyl alkylphosphonothiolates, dimethyl methylphosphonates, diisopropyl methylphosphonates, and alkylated or protonated salts thereof), o-alkyl phosphoramideocyanidates and alklylated or protonated salts thereof, phosphonic acids and esters thereof, phosphinic acids and esters thereof, phosphone oxides, phosphonites (e.g., alkyl phosphonites), phosphonium salts, alkyl phosphonyldihalides (e.g., alkyl phosphonyldifluoride and methylphosphonyl dichloride), dialkyl phosphoramidic dihalides, alkyl phosphoramidate, phosphoranes (e.g., methylenetriphenyl-phosphorane), phosphono carboxylates, halosarins (e.g., chlorosarin), halosomans (e.g., chlorosoman), amitons, alkyl phosphorus oxyhalides (e.g., alkyl phosphorus oxychloride), alkyl phosphites, phosphamidons, DNA backbone phosphate groups, DNA backbone phosphite groups, thiophosphates, selenophosphates, thiophosphyoryl esters, selenophophyoryl esters, thioesters, selenoesters and amides (such as, mono-, di- and tri-phosphate esters, thioesters and amides (P(═Y)(OH)₂(XR), P(═Y)(OH)(XR)₂, and P(═Y)(XR)₃, where X can be one of oxygen, sulfur or nitrogen, Y can be one of oxygen, sulfur and selenium and R can be a C₁-C₁₂ alkyl or aryl group), phosphatidylcholines, P—N amino compounds, monochrotophos, VX, methamidophos, dicrotophos, phosphamidons, and mixtures and combinations thereof. The phosphorus-containing target material may occur as a primary or secondary phosphorus-containing species (vide infra). One or both of the primary or secondary phosphorus-containing species may be in the form of a solid, a dissolved species, a suspension, or a combination thereof.

In some configurations, the phosphorus-containing target material comprises a phosphorus (V)-containing target material, a phosphorus (III)-containing target material, a phosphorus (II)-containing target material, or a mixture comprising one or more phosphorus (V)-, phosphorus (III)-, and phosphorus (II)-containing target materials.

In some configurations, the phosphorus-containing target material comprises reactive and/or non-reactive phosphates. “Reactive phosphorus” [RP] refers to orthophosphate (PO₄⁻³, HPO₄⁻², and H₂PO₄⁻), while “non-reactive phosphorus” [NRP] refers to polyphosphates and organic phosphorus compounds. NRP can be in the form of a colloid, or suspension. Furthermore, the NRP may be in the form of an anion, cation, and/or neutral species. In some embodiments, the NRP to RP molar and/or weight ratios (in the in the medium (or media) 104 is commonly no more than about 0.1, more commonly no more than about 0.2, more commonly no more about 0.3, more commonly no more than about 0.4, more commonly no more than about 0.5, more commonly no more than about 0.6, more commonly no more than about 0.7, more commonly no more than about 0.8, more commonly no more than about 0.9, more commonly no more than about 1.0, more commonly no more than about 1.1, more commonly no more than about 1.2, more commonly no more than about 1.3, more commonly no more than about 1.4, more commonly no more than about 1.5, more commonly no more than about 1.6, more commonly no more than about 1.7, more commonly no more about 1.8, more commonly no more than about 1.9, more commonly no more than about 1.9, and even more commonly no more than about 2.0 at a pH value of no more than about pH −2, at a pH value of more than about pH −1, at a pH value of more than about pH 0, at a pH value of more than about pH 1, at a pH value of more than about pH 2, at a pH value of more than about pH 3, at a pH value of more than about pH 4, at a pH value of more than about pH 5, at a pH value of more than about pH 6, at a pH value of more than about pH 7, at a pH value of more than about pH 8, at a pH value of more than about pH 9, at a pH value of more than about pH 10, at a pH value of more than about pH 11, at a pH value of more than about pH 12, at a pH value of more than about pH 13, or at a pH value of more than about pH 14.

It is not well understood how the rare earth-containing composition, additive and/or particles removes and/or detoxifies the phosphorus-containing target material from the medium 104. While not wishing to be bound by any theory, in some embodiments the phosphorus-containing target material and/or a portion thereof may be one or more of sorbed, precipitated, complexed, ionically bound, inter-valance shell complexed (with any one or more hybridized or non-hybridized s, p, d or f orbitals), covalently bounded or a combination thereof with the rare earth-containing composition, additive and/or particles. While not wishing to be bound by any theory, the phosphorus-containing target material and/or a portion thereof may selectively interact with a face or an edge of rare earth-containing composition, additive and/or particulate to form a target-laden rare earth composition, preferably a substantially insoluble target-laden rare earth composition. In some configurations, the rare earth composition, additive and/or particulate may be in the form of a substantially water-soluble or substantially water-insoluble rare earth composition, additive and/or particulate. In either instance, the rare earth-containing composition, additive and/or particulate chemically and/or physically strongly sorbs, binds, reacts or such with the phosphorus-containing target material to form a target-laden rare earth composition. In some embodiments, the target-laden rare earth composition is an insoluble target-laden rare earth composition.

While not wishing to be bound by any theory, in some embodiments the phosphorus-containing material and/or portion thereof is removed and/or detoxified by chemically and/or physically attaching, sorbing and/or bonding with: the phosphorus-containing material and/or portion thereof; oxygen and/or an oxygen-containing portion (such as, but not limited to an ether, alcohol, carbonyl, or carboxylate) of the phosphorus-containing material; sulfur and/or a sulfur-containing portion (such as, but not limited to a thiol-ether, thiol alcohol, thiol-carbonyl or thio-carboxylate) of the phosphorus-containing material; selenium and/or a selenium-containing portion (such as, but not limited to seleno-ether, seleno-alcohol, seleno-carbonyl, seleno-carboxylate) of the phosphorus-containing material; nitrogen and/or a nitrogen-containing portion (such as, but not limited to primary amine and/or amide, secondary amine or amide, tertiary amine or amide) of phosphorus-containing material; tellurium and/or a tellurium-containing portion (such as, but not to telluro-ether, telluro-alcohol, telluro-carbonyl, telluro-carboxylate) of the phosphorus-containing material; chlorine and/or a chlorine-containing portion of the phosphorus-containing material; carbon and/or or a carbon-containing portion (such as, a ene (double bond, sp² bond between two atoms) or yne (triple bond, sp bond between to atoms) portion) of the phosphorus-containing material; and/or a combination thereof to the rare earth or rare earth-containing composition, additive and/or particulate.

While not wishing to be bound by any theory, in some embodiments the rare earth-containing composition, additive and/or particulate comprises cerium (IV). Preferably, the cerium (IV) comprises cerium (IV) oxide. The cerium (IV) may oxidize and/or decompose the phosphorus-containing target material. While not wanting to be bound by example, the cerium (IV) may oxidize the phosphorus-containing material in the form of a phosphorus (II)- and/or phosphorus (III)-containing material to a phosphorus (IV)-containing material. The phosphorus (IV)-containing target material being one or both of more easily and effectively removed and/or detoxified than either one or both of the phosphorus (II)- and phosphorus (III)-containing target materials by the rare earth-containing composition, additive and/or particulate. While not wanting to be bound by example, the cerium (IV) may oxidize an alcoholic portion (such as, an oxygen-, sulfur-, seleno- and/or telluro-alcohol) to a carbonyl and/or carboxylate portion, respectively. The contacting of the rare earth-containing oxidizing agent and the phosphorus-containing target material may one or both: a) chemically interact with the phosphorus-containing target material and b) form a reduced rare earth and/or rare earth-containing oxidizing agent and an oxidized target material and/or portion thereof.

In some embodiments, a cerium (IV) oxidizing agent may be formed by contacting a first cerium-containing composition having cerium in a +3 oxidation state with an oxidant (vide infra) to form a second cerium-containing composition having cerium in a +4 oxidation state (or cerium (IV) oxidizing agent). Commonly, the second cerium-containing composition comprises CeO₂ particles. The cerium (IV) oxidizing agent then oxidizes the phosphorus-containing target material forming the first (reduced) cerium (III)-containing composition.

Regardless of the precise mechanism, contact of the rare earth-containing composition, additive and/or particulate with the phosphorus-containing target material forms a target-laden rare earth composition. The target-laden rare earth composition comprises the rare earth- and the phosphorus-containing target material or a component thereof. The target-laden rare earth composition can be in the form of an insoluble solid material either contained within the water or an insoluble solid material phase separated from the water. The target-laden rare earth composition may be one or more of an insoluble precipitate, an insoluble solid particle suspended within the water, a flocculated solid particle, and a combination thereof. In some configurations, the target-laden rare earth composition can be in form of solubilized and/or dissolved in the aqueous phase.

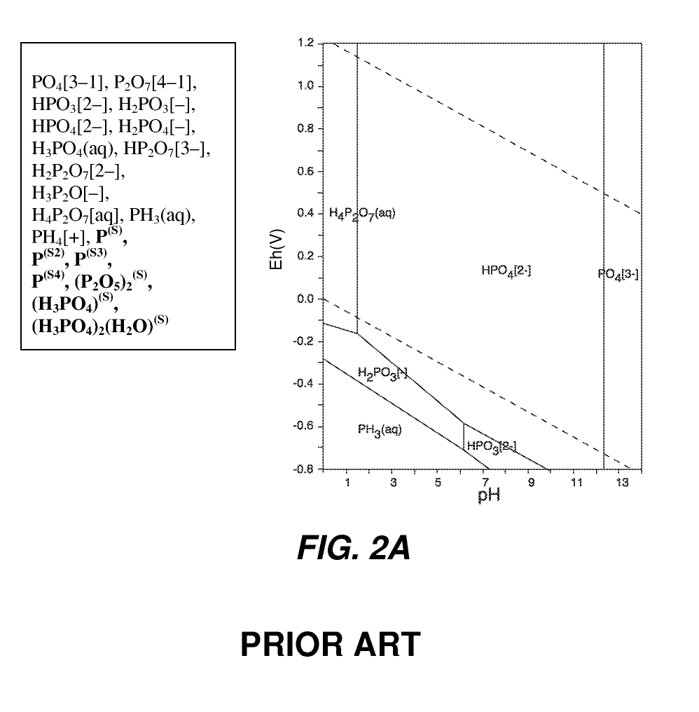

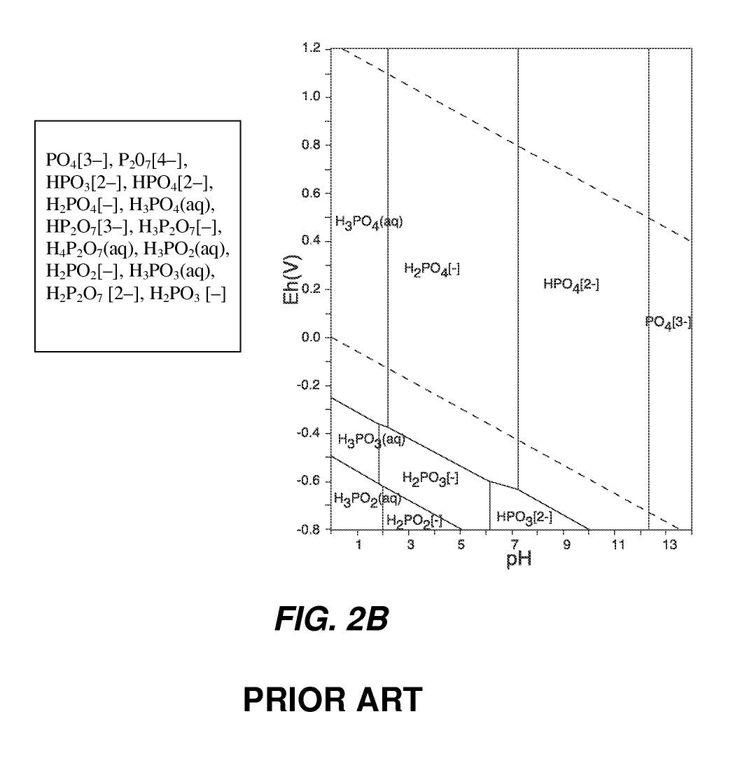

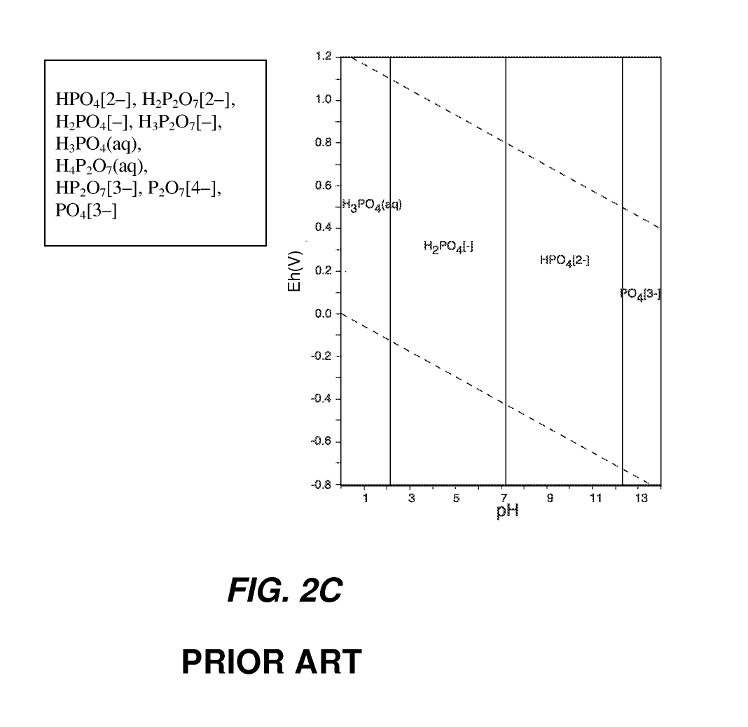

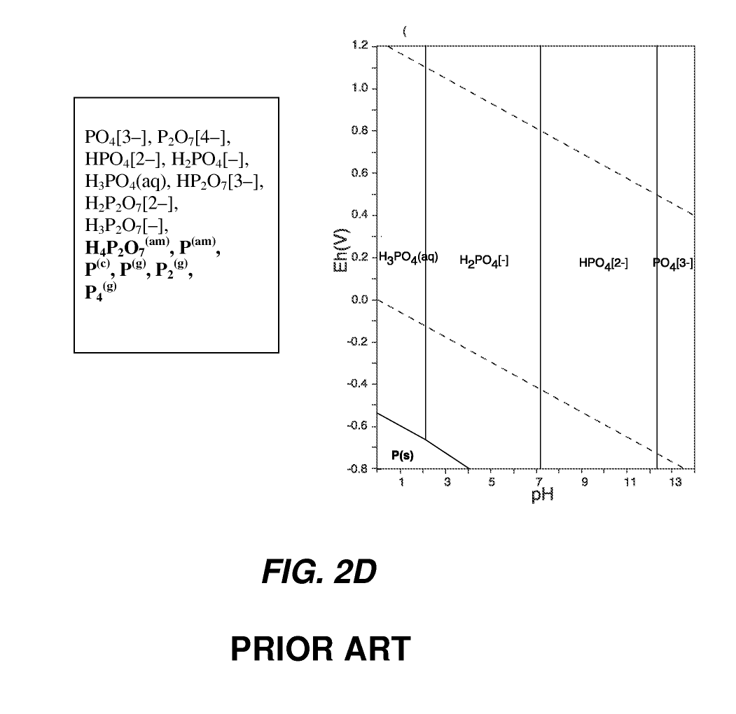

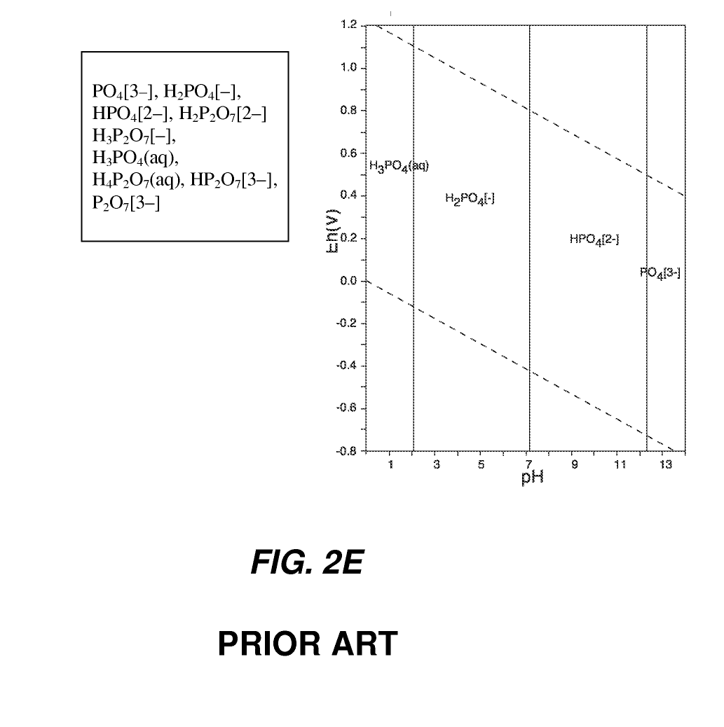

Regarding phosphorus-containing target materials in general and inorganic phosphorus-containing materials in particular, the primary phosphorus-containing species depends upon the pH and Eh of the aqueous solution. FIGS. 2A-2E area Pourbaix diagrams for phosphate under different thermodynamic conditions. As discussed below, the form of phosphate species present in solution, and therefore the efficacy of precipitating, sorbing, or otherwise removing the phosphate species from and/or detoxifying the aqueous medium by treatment with the rare earth-containing composition, additive and/or particle or particulate can be increased substantially by adjusting one or both of the pH and Eh of the aqueous solution. It can be appreciated that while the efficacy of precipitating, sorbing, or removing the phosphorus-containing target material has been illustrated for various pH and Eh values for phosphate, the concept of adjusting one or both of pH and Eh is applicable for effectively removing and/or detoxifying an aqueous solution for phosphorus-containing target materials other than phosphates.

In accordance with some embodiments, the phosphorus-containing target material is removed from the aqueous media having a selected pH value. Commonly, the selected pH value of the aqueous media may be from about pH 0 to about pH 14, more commonly the pH of the aqueous media may be from about pH 1 to about pH 13, even more commonly the pH of the aqueous media may be from about pH 2 to about pH 12, even more commonly the pH of the aqueous media may be from about pH 3 to about pH 11, yet even more commonly the pH of the aqueous media may be from about pH 4 to about pH 10, still yet even more commonly the pH of the aqueous media may be from about pH 5 to about pH 9, or still yet even more commonly the pH of the aqueous media may be from about pH 6 to about pH 8.

In one embodiment, the aqueous media typically has a selected pH value of from about pH 6 to about pH 9, and more typically the aqueous media has a pH of from about pH 6.5 to about pH 8.5

Commonly in other embodiments, the aqueous media may be substantially acidic having a selected pH of about pH 0, more commonly having a selected pH of about pH 1, even more commonly having a selected pH of about pH 2, yet even more commonly having a selected pH of about pH 3, or still yet even more commonly having a selected pH about pH 4. Even more commonly in other embodiments, the aqueous media may have a selected pH of about pH 5, more commonly having a selected pH of about pH 6, even more commonly having a selected pH of about pH 7, yet even more commonly having a selected pH of about pH 8, or still yet even more commonly having a selected pH of about pH 9. Commonly in other embodiments, the aqueous media may have a selected pH of about pH 10, more commonly having a selected pH of about pH 11, even more commonly having a selected pH of about pH 12, yet even more commonly having a selected pH of about pH 13, or still yet even more commonly having a selected pH about pH 14.

In accordance with some embodiments, the phosphorus-containing target material is removed from the aqueous medium having a selected Eh value with respect to standardized reference electrode, such as a standard hydrogen electrode (SHE). Commonly, the selected Eh of the aqueous medium is at least about −0.5 V, more commonly at least about −0.4 V, more commonly at least about −0.3 V, more commonly at least about −0.2 V, more commonly at least about −0.1 V, more commonly at least about 0 V, more commonly at least about 0.1 V, more commonly at least about 0.2 V, more commonly at least about 0.3 V, and more commonly at least about 0.4 V, and more commonly at least about 0.5 V. Commonly, the selected Eh of the aqueous medium is below the level at which water is not electrochemically stable, more commonly no more than about 1.7 V, more commonly no more than about 1.6 V, more commonly no more than about 1.5 V, more commonly no more than about 1.4 V, more commonly no more than about 1.3 V, more commonly no more than about 1.2 V, more commonly no more than about 1.1 V, more commonly no more than about 1.0 V, more commonly no more than about 0.9 V, more commonly no more than about 0.8 V, and more commonly no more than about 0.7 V.

The rare earth to phosphorus (in the phosphorus-containing target material)/target material ratio can also vary depending on the solution pH and/or Eh value. In other words, rare earths having a rare earth to phosphorus/target material ratio less than 1 have a greater molar removal capacity of phosphorus/target material than rare earths having a rare earth to phosphorus/target material ratio of 1 or more than 1. In some embodiments, the greater the pH value the greater the rare earth to phosphorus/target material ratio. In other embodiments, the greater the pH value the smaller the rare earth to phosphorus/target material ratio. In yet other embodiment, the rare earth to phosphorus/target material ratio is substantially unchanged over a range of pH values. In some embodiments, the rare earth to phosphorus/target material ratio is no more than about 0.1, the rare earth to phosphorus/target material ratio is no more than about 0.2, the rare earth to phosphorus/target material ratio is no more about 0.3, the rare earth: phosphorus/target material ratio is no more than about 0.4, the rare earth to phosphorus/target material ratio is no more than about 0.5, the rare earth to phosphorus/target material ratio is no more than about 0.6, the rare earth to phosphorus/target material ratio is no more than about 0.7, the rare earth to phosphorus/target material ratio is no more than about 0.8, the rare earth to phosphorus/target material ratio is no more than about 0.9, the rare earth to phosphorus/target material ratio is no more than about 1.0, the rare earth to phosphorus/target material ratio is no more than about 1.1, the rare earth to phosphorus/target material ratio is no more than about 1.2, the rare earth to phosphorus/target material ratio is no more than about 1.3, the rare earth to phosphorus/target material ratio is no more than about 1.4, the rare earth to phosphorus/target material ratio is no more than about 1.5, the rare earth to phosphorus/target material ratio is no more than about 1.6, the rare earth to phosphorus/target material ratio is no more than about 1.7, the rare earth to phosphorus/target material ratio is no more about 1.8, the rare earth to phosphorus/target material ratio is no more than about 1.9, the rare earth to phosphorus/target material ratio is no more than about 1.9, or the rare earth to phosphorus/target material ratio is more than about 2.0 at a pH value of no more than about pH −2, at a pH value of more than about pH −1, at a pH value of more than about pH 0, at a pH value of more than about pH 1, at a pH value of more than about pH 2, at a pH value of more than about pH 3, at a pH value of more than about pH 4, at a pH value of more than about pH 5, at a pH value of more than about pH 6, at a pH value of more than about pH 7, at a pH value of more than about pH 8, at a pH value of more than about pH 9, at a pH value of more than about pH 10, at a pH value of more than about pH 11, at a pH value of more than about pH 12, at a pH value of more than about pH 13, or at a pH value of more than about pH 14.

In some embodiments, the rare earth to phosphorus/target material ratio is no more than about 0.1, the rare earth to phosphorus/target material ratio is no more than about 0.2, the rare earth to phosphorus/target material ratio is no more about 0.3, the rare earth to phosphorus/target material ratio is no more than about 0.4, the rare earth to phosphorus/target material ratio is no more than about 0.5, the rare earth to phosphorus/target material ratio is no more than about 0.6, the rare earth to phosphorus/target material ratio is no more than about 0.7, the rare earth to phosphorus/target material ratio is no more than about 0.8, the rare earth to phosphorus/-target material ratio is no more than about 0.9, the rare earth to phosphorus/target material ratio is no more than about 1.0, the rare earth to phosphorus/target material ratio is no more than about 1.1, the rare earth to phosphorus/target material ratio is no more than about 1.2, the rare earth to phosphorus/target material ratio is no more than about 1.3, the rare earth to phosphorus/-target material ratio is no more than about 1.4, the rare earth to phosphorus/target material ratio is no more than about 1.5, the rare earth to phosphorus/target material ratio is no more than about 1.6, the rare earth to phosphorus/target material ratio is no more than about 1.7, the rare earth to phosphorus/target material ratio is no more about 1.8, the rare earth to phosphorus/target material ratio is no more than about 1.9, the rare earth to phosphorus/target material ratio is no more than about 1.9, or the rare earth to phosphorus/target material ratio is more than about 2.0 at a water pH value of no more than about pH −2, at a water pH value of more than about pH −1, at a water pH value of more than about pH 0, at a water pH value of more than about pH 1, at a water pH value of more than about pH 2, at a water pH value of more than about pH 3, at a water pH value of more than about pH 4, at a water pH value of more than about pH 5, at a water pH value of more than about pH 6, at a water pH value of more than about pH 7, at a water pH value of more than about pH 8, at a water pH value of more than about pH 9, at a water pH value of more than about pH 10, at a water pH value of more than about pH 11, at a water pH value of more than about pH 12, at a water pH value of more than about pH 13, or at a water pH value of more than about pH 14.

The concentration of the phosphorus-containing target material can vary depending on a number of factors. The concentration of either or both can be, for example, commonly at least about 1 ppm, more commonly at least about 5 ppm, more commonly at least about 10 ppm, more commonly at least about 25 ppm, 50 ppm, more commonly at least about 100 ppm, more commonly at least about 500 ppm, more commonly at least about 1,000 ppm, more commonly at least about 5,000 ppm, more commonly at least about 10,000 ppm, and more commonly at least about 100,000 ppm.

For CeO₂ as the rare earth-containing composition, additive, and/or particle or particulate, removal capacities of approximately 0.1 mg target material/g REO (e.g. CeO₂) or less can be encountered. These can have rare earth:target material ratios that are significantly larger than 2. For example, 0.1 mg is 0.0001 g, so 1 g CeO₂/0.0001 g target material=10,000. In such embodiments, the rare earth to target material ratio is commonly no more than about 50,000, the rare earth to target material ratio is more commonly no more than about 47,500, the rare earth to target material ratio is more commonly no more about 45,000, the rare earth to target material ratio is more commonly no more than about 42,500, the rare earth to target material ratio is more commonly no more than about 40,000, the rare earth to target material ratio is no more than about 37,500, the rare earth to target material ratio is more commonly no more than about 35,000, the rare earth to target material ratio is more commonly no more than about 35,000, the rare earth to target material ratio is more commonly no more than about 32,500, the rare earth to target material ratio is more commonly no more than about 30,000, the rare earth to target material ratio is more commonly no more than about 37,500, the rare earth to target material ratio is more commonly no more than about 35,000, the rare earth to target material ratio is more commonly no more than about 32,500, the rare earth to target material ratio is more commonly no more than about 30,000, the rare earth to target material ratio is more commonly no more than about 27,500, the rare earth to target material ratio is more commonly no more than about 25,000, the rare earth to target material ratio is more commonly no more than about 22,500, or the rare earth to target material ratio is more commonly no more about 20,000, at a water pH value of no more than about pH −2, at a water pH value of more than about pH −1, at a water pH value of more than about pH 0, at a water pH value of more than about pH 1, at a water pH value of more than about pH 2, at a water pH value of more than about pH 3, at a water pH value of more than about pH 4, at a water pH value of more than about pH 5, at a water pH value of more than about pH 6, at a water pH value of more than about pH 7, at a water pH value of more than about pH 8, at a water pH value of more than about pH 9, at a water pH value of more than about pH 10, at a water pH value of more than about pH 11, at a water pH value of more than about pH 12, at a water pH value of more than about pH 13, or at a water pH value of more than about pH 14.

### Aqueous Medium Pre-Treatment

In step 108, the medium 104 is optionally pre-treated to produce a selected primary species of the phosphorus-containing target material. The selected primary species is generally more effectively removed by the rare earth-containing composition, additive, and/or particle than the primary species in the medium 104. For example, one or more of the Eh and pH values may be altered for more effective removal and/or detoxification the phosphorus-containing target material from the medium 104. As will be appreciated, pH is a measure of the activity of hydrogen ions while Eh is a measure of the electrochemical (oxidation/reduction) potential.

The type of pre-treatment employed can depend on the application.

In one application, an acid, acid equivalent, base, or base equivalent is added to adjust the pH to a desired pH value. Examples of acids or acid equivalents include monoprotic acids and polyprotic acids, such as mineral acids, sulfonic acids, carboxylic acids, vinylogous carboxylic acids, nucleic acids, and mixtures thereof. Examples of bases and base equivalents include strong bases (such as potassium hydroxide, barium hydroxide, cesium hydroxide, sodium hydroxide, strontium hydroxide, calcium hydroxide, magnesium hydroxide, lithium hydroxide, and rubidium hydroxide), superbases, carbonates, ammonia, hydroxides, metal oxides (particularly alkoxides), and counter anions of weak acids.

In one application, oxidation and reduction reactions can be used to adjust the Eh value. Eh is a measure of the oxidation or reduction potential of the medium 104. The oxidation or reduction potential is commonly referred to as electromotive force or EMF. The EMF is typically measured with respect to a standardized reference electrode. Non-limiting examples of standardized reference electrodes are hydrogen electrode (commonly referred to as SHE), copper/copper sulfate electrode, and silver/silver chloride to name a few.

In one variation, the phosphorus-containing target material is contacted with an oxidizing agent to oxidize the phosphorus-containing target material to form a primary species. The oxidizing agent may comprise a chemical oxidizing agent, an oxidation process, or combination of both.

A chemical oxidizing agent comprises a chemical composition in elemental or compounded form. The chemical oxidizing agent accepts an electron from the phosphorus-containing target material. In the accepting of the electron, the oxidizing agent is reduced to form a reduced form of the oxidizing agent. Non-limiting examples of preferred chemical oxidizing agents are chlorine, chloroamines, chlorine dioxide, hypochlorites, trihalomethane, haloacetic acid, ozone, hydrogen peroxide, peroxygen compounds, hypobromous acid, bromoamines, hypobromite, hypochlorous acid, isocyanurates, tricholoro-s-triazinetriones, hydantoins, bromochloro-dimethyldantoins, 1-bromo-3-chloro-5,5-dimethyldantoin, 1,3-dichloro-5,5-dimethyldantoin, sulfur dioxide, bisulfates, and combinations thereof. It is further believed that in some configurations one or more the following chemical compositions may oxidize the phosphorus-containing target material: bromine, Bra, permanganates, phenols, alcohols, oxyanions, arsenites, chromates, trichloroisocyanuric acid, and surfactants. The chemical oxidizing agent may further be referred to as an “oxidant” or an “oxidizer”.

An oxidation process comprises a physical process that alone or in combination with a chemical oxidizing agent. The oxidation process removes and/or facilitates the removal an electron from the phosphorus-containing target material. Non-limiting examples of oxidation processes are electromagnetic energy, ultra violet light, thermal energy, ultrasonic energy, and gamma rays.

In another variation, the phosphorus-containing target material is contacted with a reducing agent to reduce the phosphorus-containing target material and form a primary species. The oxidizing agent may comprise a chemical oxidizing agent, an oxidation process, or combination of both.

A chemical reducing agent comprises a chemical composition in elemental or compounded form. The chemical reducing agent donates an electron to the phosphorus-containing target material to form the primary species. In the donating the electron, the reducing agent is oxidized to form an oxidized form of the reducing agent. Non-limiting examples of preferred chemical reducing agents are lithium aluminum hydride, nascent (atomic) hydrogen, sodium amalgam, sodium borohydride, compounds containing divalent tin ion, sulfite compounds, hydrazine, zinc-mercury amalgam, diisobutylaluminum hydride, Lindlar catalyst, oxalic acid, formic acid, ascorbic acid, phosphites, hypophosphites, phosphorus acids, dithiothreitols, and compounds containing the divalent iron ion. The chemical reducing agent may further be referred to as a “reductant” or a “reducer”.

A redox process is a physical process that alone or in combination with a chemical oxidizing agent transfers electrons to or form a target material. Non-limiting examples of oxidation processes are electromagnetic energy, ultra violet light, thermal energy, ultrasonic energy, gamma rays, and biological processes.

In one variation, the aqueous media is contacted with a halogenated species, such as chlorine, bromine, iodine, or an acid, base, or salt thereof. As will be appreciated, halogens impact the Eh of the aqueous media. In some configurations, halogens can impact the pH value of the aqueous media.

Other types of pre-treatment may be employed to remove species from the aqueous media that can impair removal of the phosphorus-containing target material and/or adjustment of the pH and/or Eh of the aqueous media.

The pre-treatment can comprise one or more of clarifying, disinfecting, coagulating, aerating, filtering, separating solids and liquids, digesting, and polishing processes. More specifically, the pre-treatment process can commonly comprise one of clarifying, disinfecting, coagulating, aerating, filtering, separating solids and liquids, digesting, and polishing processes, more commonly any two of clarifying, disinfecting, coagulating, aerating, filtering, separating solids and liquids, digesting, and polishing processes arranged in any order, even more commonly any three of clarifying, disinfecting, coagulating, aerating, filtering, separating solids and liquids, digesting, and polishing processes arranged in any order, yet even more commonly any four of clarifying, disinfecting, coagulating, aerating, filtering, separating solids and liquids, digesting, and polishing processes arranged in any order, still yet even more commonly any five of clarifying, disinfecting, coagulating, aerating, filtering, separating solids and liquids, digesting, and polishing processes arranged in any order, still yet even more commonly any six of clarifying, disinfecting, coagulating, aerating, filtering, separating solids and liquids, digesting, and polishing processes arranged in any order, still yet even more commonly any seven of clarifying, disinfecting, coagulating, aerating, filtering, separating solids and liquids, digesting, and polishing processes arranged in any order, still yet even more commonly any eight of clarifying, disinfecting, coagulating, aerating, filtering, separating solids and liquids, digesting, and polishing processes arranged in any order, still yet even more commonly any nine of clarifying, disinfecting, coagulating, aerating, filtering, separating solids and liquids, digesting, and polishing processes arranged in any order, still yet even more commonly any ten of clarifying, disinfecting, coagulating, aerating, filtering, separating solids and liquids, digesting, and polishing processes arranged in any order, still yet even more commonly any eleven of clarifying, disinfecting, coagulating, aerating, filtering, separating solids and liquids, digesting, and polishing processes arranged in any order, and yet still even more commonly each of clarifying, disinfecting, coagulating, aerating, filtering, separating solids and liquids, digesting, and polishing process arranged in any order. In some configurations, the pre-treatment may comprise or may further comprise processing by one or more of the additional process equipment of the water-handling system.

### Contact of Aqueous Media with Rare Earth-Containing Additive

In step 112, the optionally pre-treated medium 104 is contacted with the rare earth-containing composition, additive, or particle to form the target-laden rare earth composition. Contact can be added by any suitable technique, including not only adding the rare earth-containing composition, additive or particle (as a water soluble, partially soluble, or insoluble form) to the pre-treated medium 104 or vice versa but also forming the rare earth-containing composition, additive, or particle in situ in the pre-treated medium 104. As noted, the rare earth-containing composition, additive and/or particulate chemically and/or physically reacts with, sorbs, precipitates, transforms, or otherwise deactivates or binds with the phosphorus-containing target material and/or portion thereof. In one configuration, the rare earth-containing composition, additive and/or particulate chemically and/or physically reacts with, sorbs, precipitates, transforms, or otherwise deactivates or binds with at least about 25%, more commonly at least about 50%, more commonly more commonly more than about 50%, more commonly at least about 75%, and even more commonly at least about 95% of the phosphorus-containing target material or portion thereof. The target-laden rare earth composition includes the rare earth and one or both of the phosphorus-containing target material and one or more constituents, components or portion of the phosphorus-containing target material, and, in some cases, one or more other constituents, components or portion of the rare earth-containing composition, additive and/or particulate.

The temperature of the medium 104 during the contacting step can vary. Typically, the temperature of the aqueous solution can vary during the contacting step. For example, temperature of aqueous solution can vary depending on the source of the water. Commonly, the temperature of the aqueous solution is ambient temperature. Typically, the aqueous solution temperature ranges from about −5 degrees Celsius to about 50 degrees Celsius, more typically from about 0 degrees Celsius to about 45 degrees Celsius, yet even more typically from about 5 degrees Celsius to about 40 degrees Celsius and still yet even more typically from about 10 degrees Celsius to about 35 degrees Celsius. It can be appreciated that each of the waters comprising each of the clarifying, disinfecting, coagulating, aerating, filtering, separating solids and liquids, digesting, and polishing processes may include optional processing units and/or operations that heat and/or cool one or more of each of the waters. In some configurations, each of the waters may be heated to have a temperature of typically at least about 20 degrees Celsius, more typically at least about 25 degrees Celsius, even more typically at least about 30 degrees Celsius, yet even more typically of at least about 35 degrees Celsius, still yet even more typically of at least about 40 degrees Celsius, still yet even more typically of at least about 45 degrees Celsius, still yet even more typically of at least about 50 degrees Celsius, still yet even more typically of at least about 60 degrees Celsius, still yet even more typically of at least about 70 degrees Celsius, still yet even more typically of at least about 80 degrees Celsius, still yet even more typically of at least about 90 degrees Celsius, still yet even more typically of at least about 100 degrees Celsius, still yet even more typically of at least about 110 degrees Celsius, still yet even more typically of at least about 120 degrees Celsius, still yet even more typically of at least about 140 degrees Celsius, still yet even more typically of at least about 150 degrees Celsius, or still yet even more typically of at least about 200 degrees Celsius. In some configurations, each of the waters comprising each of the clarifying, disinfecting, coagulating, aerating, filtering, separating solids and liquids, digesting, and polishing processes may be cooled to have a temperature of typically of no more than about 110 degrees Celsius, more typically of no more than about 100 degrees Celsius, even more typically of no more than about 90 degrees Celsius, yet even more typically of no more than about 80 degrees Celsius, still yet even more typically of no more than about 70 degrees Celsius, still yet even more typically of no more than about 60 degrees Celsius, still yet even more typically of no more than about 50 degrees Celsius, still yet even more typically of no more than about 45 degrees Celsius, still yet even more typically of no more than about 40 degrees Celsius, still yet even more typically of no more than about 35 degrees Celsius, still yet even more typically of no more than about 30 degrees Celsius, still yet even more typically of no more than about 25 degrees Celsius, still yet even more typically of no more than about 20 degrees Celsius, still yet even more typically of no more than about 15 degrees Celsius, still yet even more typically of no more than about 10 degrees Celsius, still yet even more typically of no more than about 5 degrees Celsius, or still yet even more typically of no more than about 0 degrees Celsius.

### Separation of Target-Laden Rare Earth Composition from Aqueous Media

In optional step 116, the target-laden rare earth composition is removed from the aqueous medium (medium 104) to form a treated aqueous medium 124. In one configuration, commonly at least about 25%, more commonly at least about 50%, more commonly more commonly more than about 50%, more commonly at least about 75%, and even more commonly at least about 95% of the target-laden rare earth composition is removed from the aqueous media. It can be appreciated that in such instances, the target-laden rare earth composition comprises an insoluble material.

The target-laden rare earth composition may be removed by any suitable technique, such as by a liquid/solid separation system. Non-limiting examples of liquid/solid separation systems are filtration, floatation, sedimentation, cyclone, and centrifuging. Alternatively, the rare earth-containing additive is in the form of a particulate bed or supported porous and permeable matrix, such as a filter, through which the media passes.

Alternatively, the target-laden rare earth composition, dissolved in the water, may remain in the water in a de-activated form. Non-limiting examples of de-activated target-laden rare earth composition that may remain dissolved are environmentally stable co-ordination complexes of a primary or secondary phosphorus-containing species and the rare earth-containing composition.

In accordance with some embodiments, the treated aqueous medium 124 has a lower content of at least one of the one or more phosphorus-containing target materials compared to the aqueous medium 104. Commonly, the treated aqueous medium 124 content for at least one of the one or more phosphorus-containing target materials is at least about 0.9 of that for the aqueous medium 104, more commonly the treated aqueous medium 124 content for at least one of the one or more phosphorus-containing target materials is at least about 0.8 of that for the aqueous medium 104, even more commonly the treated aqueous medium 124 content for at least one of the one or more phosphorus-containing target materials is at least about 0.7 of that for the aqueous medium 104, yet even more commonly the treated aqueous medium 124 content for at least one of the one or more phosphorus-containing target materials is at least about 0.6 of that for the aqueous medium 104, still yet even more commonly the treated aqueous media 124 content for at least one of the one or more phosphorus-containing target materials is at least about 0.5 of that for the aqueous medium 104, still yet even more commonly the treated aqueous medium 124 content for at least one of the one or more phosphorus-containing target materials is at least about 0.4 of that for the aqueous medium 104, still yet even more commonly the treated aqueous medium 124 content for at least one of the one or more phosphorus-containing target materials is at least about 0.3 of that for the aqueous medium 104, still yet even more commonly the treated aqueous medium 124 content for at least one of the one or more phosphorus-containing target materials is at least about 0.2 of that for the aqueous medium 104, still yet even more commonly the treated aqueous medium 124 content for at least one of the one or more phosphorus-containing target materials is at least about 0.1 of that for the aqueous medium 104, still yet even more commonly the treated aqueous medium 124 content for at least one of the one or more phosphorus-containing target materials is at least about 0.05 of that for the aqueous medium 104, still yet even more commonly the treated aqueous medium 124 content for at least one of the one or more phosphorus-containing target materials is at least about 0.01 of that for the aqueous medium 104, still yet even more commonly the treated aqueous medium 124 content for at least one of the one or more phosphorus-containing target materials is at least about 0.005 of that for the aqueous medium 104, still yet even more commonly the treated aqueous medium 124 content for at least one of the one or more phosphorus-containing target materials is at least about 0.001 of that for the aqueous medium 104, still yet even more commonly the treated aqueous medium 124 content for at least one of the one or more phosphorus-containing target materials is at least about 0.5 of that for the aqueous medium 104, still yet even more commonly the treated aqueous medium 124 content for at least one of the one or more phosphorus-containing target materials is at least about 0.0005 of that for the aqueous medium 104, still yet even more commonly the treated aqueous medium 124 content for at least one of the one or more phosphorus-containing target materials is at least about 0.0001 of that for the aqueous medium 104, still yet even more commonly the treated aqueous medium 124 content for at least one of the one or more phosphorus-containing target materials is at least about 5×10⁻⁵ of that for the aqueous medium 104, still yet even more commonly the treated aqueous medium 124 content for at least one of the one or more phosphorus-containing target materials is at least about 1×10⁻⁵ of that for the aqueous medium 104, still yet even more commonly the treated aqueous medium 124 content for at least one of the one or more phosphorus-containing target materials is at least about 5×10⁻⁶ of that for the aqueous medium 104, and still yet even more commonly the treated aqueous medium 124 content for at least one of the one or more phosphorus-containing target materials is at least about 1×10⁻⁶ of that for the aqueous medium 104. Typically, the phosphorus-containing target material content in the treated aqueous medium 124 is no more than about 100,000 ppm, more typically the phosphorus-containing target material content in the treated aqueous medium 124 is no more than about 10,000 ppm, even more typically the phosphorus-containing target material content in the treated aqueous medium 124 is no more than about 1,000 ppm, yet even more typically the phosphorus-containing target material content in the treated aqueous medium 124 is no more than about 100 ppm, still yet even more typically the phosphorus-containing target material content in the treated aqueous medium 124 is no more than about 10 ppm, still yet even more typically the phosphorus-containing target material content in the treated aqueous medium 124 is no more than about 1 ppm, still yet even more typically the phosphorus-containing target material content in the treated aqueous medium 124 is no more than about 100 ppb, still yet even more typically the phosphorus-containing target material content in the treated aqueous medium 124 is no more than about 10 ppb, still yet even more typically the phosphorus-containing target material content in the treated aqueous medium 124 is no more than about 1 ppb, and yet still even more typically the phosphorus-containing target material content in the treated aqueous medium 124 is no more than about 0.1 ppb.

Step 116 can include optional treatment steps.

The treatment can comprise one or more of clarifying, disinfecting, coagulating, aerating, filtering, separating solids and liquids, digesting, and polishing processes. More specifically, the treatment process can commonly comprise one of clarifying, disinfecting, coagulating, aerating, filtering, separating solids and liquids, digesting, and polishing, more commonly any two of clarifying, disinfecting, coagulating, aerating, filtering, separating solids and liquids, digesting, and polishing arranged in any order, even more commonly any three of clarifying, disinfecting, coagulating, aerating, filtering, separating solids and liquids, digesting, and polishing arranged in any order, yet even more commonly any four of clarifying, disinfecting, coagulating, aerating, filtering, separating solids and liquids, digesting, and polishing arranged in any order, still yet even more commonly any five of clarifying, disinfecting, coagulating, aerating, filtering, separating solids and liquids, digesting, and polishing arranged in any order, still yet even more commonly any six of clarifying, disinfecting, coagulating, aerating, filtering, separating solids and liquids, digesting, and polishing arranged in any order, still yet even more commonly any seven of clarifying, disinfecting, coagulating, aerating, filtering, separating solids and liquids, digesting, and polishing arranged in any order, still yet even more commonly any eight of clarifying, disinfecting, coagulating, aerating, filtering, separating solids and liquids, digesting, and polishing arranged in any order, still yet even more commonly any nine of clarifying, disinfecting, coagulating, aerating, filtering, separating solids and liquids, digesting, and polishing arranged in any order, still yet even more commonly any ten of clarifying, disinfecting, coagulating, aerating, filtering, separating solids and liquids, digesting, and polishing arranged in any order, still yet even more commonly any eleven of clarifying, disinfecting, coagulating, aerating, filtering, separating solids and liquids, digesting, and polishing arranged in any order, and yet still even more commonly each of clarifying, disinfecting, coagulating, aerating, filtering, separating solids and liquids, digesting, and polishing arranged in any order.

### Regeneration of Rare Earth for Recycle

The separated product may be subjected to suitable processes for removal of the phosphorus-containing target material or portions thereof from the target-laden rare earth composition to enable the rare earth to be recycled to step 112. Regeneration processes include, for example, desorption, oxidation, reduction, thermal processes, irradiation, and the like.

As used herein cerium (III) may refer to cerium (+3), and cerium (+3) may refer to cerium (III). As used herein cerium (IV) may refer to cerium (+4), and cerium (+4) may refer to cerium (IV).

Some embodiments include a method comprising contacting an aqueous medium having a phosphorus-containing target material with a rare earth-containing additive to remove at least a portion of the phosphorus-containing target material from the aqueous medium to form a treated aqueous medium. In accordance with some embodiments, the phosphorus-containing target material comprises one or more of phosphoric acid, phospho-imide, phosphinate, phosphinite, non-fluoridated phosphonates, o-alkyl phosphoramideocyanidate, phosphonic acid, phosphinic acid, phosphonite, dialkyl phosphoramidic dihalide, alkyl phosphoramidate, DNA backbone phosphate group, thiophosphate, thiophosphyoryl ester, thiophosphyoryl thioester, thiophosphyoryl amide, phosphatidylcholine, P—N amino compound, alklylated P—N amino compound, and P—N amino ester. Preferably, the rare earth-containing additive is primarily in the form of cerium (IV), cerium (III) or a mixture of cerium (IV) and cerium (III). Optionally, the rare earth-containing additive is water-soluble. Optionally, the rare earth-containing additive is water-insoluble. In accordance with some embodiments, the contacting step may further include: contacting the aqueous medium with an oxidizing agent to oxidize the phosphorus-containing target material to form an oxidized phosphorus-containing target material, the oxidized phosphorus-containing target mater having one or both of a different structure and composition than the phosphorus-containing target material; and thereafter contacting, in the aqueous medium, the rare earth-containing additive with the oxidized phosphorus-containing target material to remove the oxidized phosphorus-containing target material. In accordance with some embodiments, the contacting step may further include: contacting the aqueous medium with a reducing agent to reduce the phosphorus-containing target material to form a reduced phosphorus-containing target material, the reduced phosphorus-containing target material having one or both of a different structure and composition than the phosphorus-containing target material; and thereafter contacting, in the aqueous medium, the rare earth-containing additive with the reduced target phosphorus-containing target material to remove the reduced phosphorus-containing target material. In accordance with some embodiments, the contacting step may further include: contacting the aqueous medium with a base and/or base equivalent to convert the phosphorus-containing target material to a primary species different from the phosphorus-containing target material; and thereafter contacting, in the aqueous medium, the rare earth-containing additive with the primary species to remove the primary species. In accordance with some embodiments, the contacting step may further include: contacting the aqueous medium with an acid and/or acid equivalent to convert the phosphorus-containing target material to a primary species different from the phosphorus-containing target material; and thereafter contacting, in the aqueous medium, the rare earth-containing additive with the primary species to remove the primary species. In accordance with some embodiments, the phosphorus-containing target material is selected from the group consisting essentially of phosphoric acid, phosphinate, phosphinite, non-fluoridated phosphonates, phosphonic acid, phosphinic acid, phosphonite, thiophosphate, thiophosphyoryl ester, and thiophosphyoryl thioester. In accordance with some embodiments, the phosphorus-containing target material comprises phosphatidylcholine. In accordance with some embodiments, the phosphorus-containing target material comprises one or more of a P—N amino compound, alklylated P—N amino compound, and P—N amino ester. In accordance with some embodiments, the phosphorus-containing target material comprises one or more of a phospho-imide, o-alkyl phosphoramideocyanidate, dialkyl phosphoramidic dihalide, alkyl phosphoramidate, and thiophosphyoryl amide. In accordance with embodiments, the phosphorus-containing target material comprises a DNA backbone phosphate group.

Some embodiments include a composition comprising an aqueous medium, a rare earth-containing additive, a phosphorus-containing target material, and a target-laden rare earth composition formed by the rare earth-containing additive and the phosphorus-containing target material. Preferably, the phosphorus-containing target material comprises one or more of one or more of phosphoric acid, phospho-imide, phosphinate, phosphinite, non-fluoridated phosphonates, o-alkyl phosphoramideocyanidate, phosphonic acid, phosphinic acid, phosphonite, dialkyl phosphoramidic dihalide, alkyl phosphoramidate, DNA backbone phosphate group, thiophosphate, thiophosphyoryl ester, thiophosphyoryl thioester, thiophosphyoryl amide, phosphatidylcholine, P—N amino compound, alklylated P—N amino compound, and P—N amino ester. The rare earth-containing additive preferably comprises primarily cerium and wherein the target-laden rare earth composition is a complex formed by the rare earth-containing additive and phosphorus-containing target material. In accordance with some embodiments, the rare earth-containing additive may comprise primarily cerium and the target-laden rare earth composition may be formed by sorption of the phosphorus-containing target material by the rare earth-containing additive. In accordance with some embodiments, the rare earth-containing additive may comprise primarily cerium and the target-laden rare earth composition may be formed by a chemical reaction between the phosphorus-containing target material and the rare earth-containing additive. Optionally, the rare earth-containing additive is water-soluble. Optionally, the rare earth-containing additive is water-insoluble. In accordance with some embodiments, the phosphorus-containing target material may be selected from the group consisting essentially of phosphoric acid, phosphinate, phosphinite, non-fluoridated phosphonates, phosphonic acid, phosphinic acid, phosphonite, thiophosphate, thiophosphyoryl ester, and thiophosphyoryl thioester. In accordance with some embodiments, the phosphorus-containing target material may comprise phosphatidylcholine. In accordance with some embodiments, the phosphorus-containing target material may comprise one or more of a P—N amino compound, alklylated P—N amino compound, and P—N amino ester. In accordance with some embodiments, the phosphorus-containing target material may comprise one or more of a phospho-imide, o-alkyl phosphoramideocyanidate, dialkyl phosphoramidic dihalide, alkyl phosphoramidate, and thiophosphyoryl amide. In some embodiments, the phosphorus-containing target material may comprise a DNA backbone phosphate group.

### EXAMPLES

The following examples are provided to illustrate certain embodiments and are not to be construed as limitations on the embodiments, as set forth in the appended claims. All parts and percentages are by weight unless otherwise specified.

### Example 1

ABS plastic filter housings (1.25 inches in diameter and 2.0 inches in length) were packed with ceric oxide (CeO₂) that was prepared from the thermal decomposition of 99% cerium carbonate. The housings were sealed and attached to pumps for pumping an aqueous solution through the housings. The aqueous solutions were pumped through the material at flow rates of 50 and 75 ml/min. A gas chromatograph was used to measure the final content of the chemical contaminant. The chemical contaminants tested, their initial concentration in the aqueous solutions, and the percentage removed from solution are presented in Table 1.

TABLE 1

| | | Starting | | |
|---|---|---|---|---|
| | | Concentration | % Removal at | % Removal at |
| Common Name | Chemical Name | (mg/L) | 50 ml/min | 75 ml/min |
| VX | O-ethyl-S-(2- | 3.0 | 99% | 97% |
| | isopropylaminoethyl) | | | |
| | methylphosphonothiolate | | | |
| GB (sarin) | Isopropyl | 3.0 | 99.9% | 99.7% |
| | methlphosphonofluoridate | | | |
| Methamidophos | O,S-dimethyl | 0.184 | 95% | 84% |
| | phosphoramidothioate | | | |
| Monochrotophos | Dimethyl (1E)-1-methyl-3- | 0.231 | 100% | 100% |
| | (methylamino)-3-oxo-1- | | | |
| | propenylphosphate | | | |
| Phosphamidon | 2-chloro-3-(diethylamino)- | 0.205 | 100% | 95% |
| | 1-methyl-3-oxo-1-propenyl | | | |
| | dimethylphosphate | | | |

### Example 2

Experiments were performed at ambient (room) temperature to remove various phosphorus-containing target materials from de-ionized and NSF standardized waters using cerium (IV) oxide.

The constituents of the NSF standardized solution, in accordance with NSF P231 “general test water 2” (“NSF”), are shown in Tables 2-5:

TABLE 2
Amount of Reagents Added

| | | Amount of |
|---|---|---|
| | Amount of | Reagent Added to |
| | Reagent Added | 3.5 L (g) No |
| Compound | to 3.5 L (g) | Fluoride |
| NaF | 5.13 | 0 |
| AlCl₃•6H₂O | 0.13 | 0.13 |
| CaCl₂•2H₂O | 0.46 | 0.46 |
| CuSO₄•5H₂O | 0.06 | 0.06 |
| FeSO₄•7H₂O | 2.17 | 2.16 |
| KCl | 0.16 | 0.15 |
| MgCl₂•6H₂O | 0.73 | 0.74 |
| Na₂SiO₃•9H₂O | 1.76 | 1.76 |
| ZnSO₄•7H₂O | 0.17 | 0.17 |
| Na₂HAsO₄•7H₂O | 18.53 | 18.53 |

TABLE 3
Calculated Analyte Concentration

| | | Theoretical |
|---|---|---|
| | Theoretical | Concentration |
| | Concentration | (mg/L) No |
| Element | (gm/L) | Fluoride |
| Cl | 19032 | 15090 |
| Na | 1664 | 862 |
| K | 24 | 22 |
| Cu | 4 | 4 |
| Fe | 125 | 124 |
| Zn | 11 | 11 |
| As | 1271 | 1271 |
| Mg | 25 | 20 |
| Ca | 36 | 36 |
| Al | 16 | 16 |
| Si | 50 | 50 |
| S | 79 | 79 |
| F | 663 | 0 |

Media Preparation:

20 mg of Molycorp HSA cerium (IV) oxide was measured out in a plastic weigh boat for each sample to be tested. Approximately 10 mL of DI was added to the weigh boat and the media was allowed to wet for 30 minutes.

Influent Preparation:

The 30 mL stock solutions were prepared from solid or liquid reagents for each of the reagents in question. Influents were prepared from the stock solutions in 2.5 L batches for each reagent in question. 2.5 L of DI was measured out gravimetrically into a 4 L bottle. HEPES sodium buffer was added to the DI water followed by 2.5 mL of the stock solutions. The pH was adjusted to 7.5±0.25 using 1 N HCl and 1 N NaOH.

Isotherm Preparation:

500 mL of influent was measured out gravimetrically into four 500 mL bottles. Three bottles were labeled as a samples and the last was labeled as a control. The previously prepared media was poured into each sample bottle. Bottles were capped and sealed with electrical tape. Each bottle was then placed within a rolling container that could hold up to 10 bottles. The containers were then sealed with duct tape and placed on the rolling apparatus. Samples and controls were rolled for 24 hours. After 24 hours, the rolling containers were removed from the apparatus and the bottles were retrieved from the containers. A 10-45 mL sample of each solution was taken and filtered with a 0.2 μm filter. Samples were analyzed either by a third party laboratory or with a HACH® colorimeter.

Total phosphorus was analyzed with a HACH® DR/890 colorimeter according to the HACH® Method 8190 for total phosphorus as phosphate. Briefly, the sample is pretreated with sulfuric acid and persulfate under heat to hydrolyze organic and inorganic phosphorus to orthophosphate, and then reacted with molybdate in an acid medium to produce a phosphomolybdate complex. The sample is then reduced with ascorbic acid, resulting in a blue-colored compound, which is measured spectroscopically.

The abilities of cerium (IV) oxide to remove phosphate and various organophosphorus target materials were also tested.

The results are presented in Table 4:

TABLE 4

| | | Removal Level |
|---|---|---|
| | Contaminant | DI |
| | Phosphate | Yes |
| Phospho-organics | Cyclophosphamide | Apparent Removal |
| | Diazinon | Apparent Removal |
| | Dimethylphosphinic Acid | Removed |
| | Ethyl Methylphosphonate | No Apparent Removal |
| | Glyphosate | No Apparent Removal |
| | Malathion | No Apparent Removal |
| | Phosphatidylcholine | Removed |
| | Sodium Phosphonoformate | Removed |
| | tribasic hexahydrate | |
| | Triethyl phosphate | No Apparent Removal |
| | Tris(dimethylamino) | Removed |
| | phosphine | |

Table 5 presents the removal capacities of cerium (IV) oxide for phosphate.

TABLE 5

| | Removal Capacity (mg/g) of |
|---|---|
| | Cerium (IV) oxide |
| Contaminant | NSF |
| Phosphate | 35.57 |

### Example 3

This example demonstrates the successful removal of sulfate-containing compounds, halogenated compounds, carbonate-containing compounds, and phosphate-containing compounds, using a cerium (IV) dioxide powder. A cerium powder, having a 400 ppb arsenic removal capacity, was contacted with various solutions containing arsenic (III) as arsenite and arsenic (V) as arsenate and elevated concentrations of the compounds that compete for the known binding affinity between arsenic and cerium. The competing compounds included sulfate ions, fluoride ions, chloride ions, carbonate ions, silicate ions, and phosphate ions at concentrations of approximately 500% of the corresponding NSF concentration for the ion. The cerium dioxide powder was further contacted with arsenic-contaminated distilled and NSF P231 “general test water 2” (“NSF”) water (Tables 3-5). Distilled water was used for the baseline measurement.

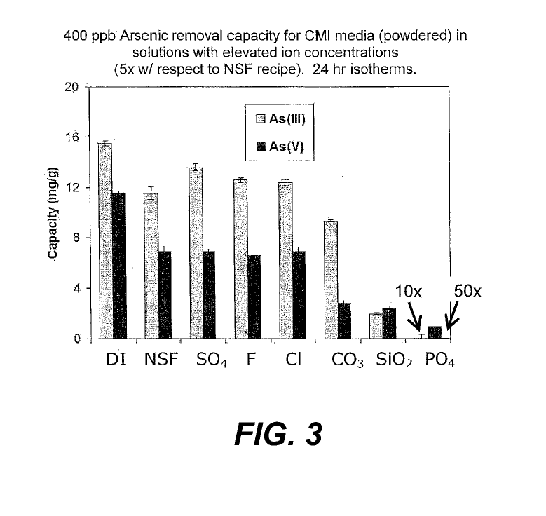

The results are presented in FIG. 3. As can be seen from FIG. 3, the ions in NSF water caused, relative to distilled water, a decreased cerium dioxide capacity for both arsenite and arsenate, indicating a successful binding of these compounds to the rare earth metal. The presence of carbonate ion decreased the cerium dioxide removal capacity for arsenate more than arsenite. The presence of silicate ion decreased substantially cerium dioxide removal capacities for both arsenite and arsenate. Finally, phosphate ion caused the largest decrease in cerium dioxide removal capacities for arsenite (10×NSF concentration) and arsenate (50×NSF concentration), with the largest decrease in removal capacity being for arsenite. In other words, the preference of cerium dioxide for phosphate anion is greater than its preference for arsenite and arsenate.

### Example 4

Example 4 is a control having about 0.2 g of struvite, NH₄MgPO₄.6H₂O, particles mixed in about 0.1 L of a 0.15 mol/L acidic ferric chloride, FeCl₃, solution. The molar ratio of ferric chloride to struvite was about 1.0 and the initial pH of the solution was about pH 2.5. The initial pH of the control solution was low enough to dissolve the struvite without the presence of ferric chloride. A magnetic stir-bar was used to stir the control solution. After stirring for at least about 16 hours, the solids were filtered from the control solution. The filtered solids were analyzed by x-ray diffraction and the control solution was analyzed by ICP-MS. Final solution pH value was about pH 2.3. The results are summarized in Table 6.

TABLE 6

| Nominal Concentrations | | | | | | Residual Concentrations | | | | |
|---|---|---|---|---|---|---|---|---|---|---|
| Metal | Struvite | pH | Mg | P | REE | pH | Mg | P | Metal | P |
| Element | (mg) | Initial | (ppm) | (ppm) | (ppm) | Final | (ppm) | (ppm) | (ppm) | Removal |
| Fe | 200 | 2.5 | 198 | 252 | 454 | 2.3 | 190 | 22 | 2.2 | 91.3% |

The Example 4 shows that struvite can be more effectively removed with rare earth-containing compositions than with other removal materials such as ferric chloride.

### Example 5

An experiment was performed to remove reactive and non-f phosphorus from waste water utilizing cerium (III) chloride.

The parameters for the experiment were as follows:

Material: Waste Water (Influent, Effluent), Cerium Chloride (0.22 M or 37.8 g/L TREO)

Solutions:

TABLE 7
Waste Water Samples

| | Initial Reactive | Initial Total | Initial Non-Reactive | |
|---|---|---|---|---|
| Waste Water | [P] | [P] | [P] | Initial |
| Sample | (mg/L) | (mg/L) | (mg/L) | pH |
| Influent | 9.4 | 10.9 | 1.5 | 6.81 |
| Effluent | 6.3 | 7.1 | 0.8 | 7.01 |

Reaction Time: 16 hours

Reaction Volume: 250 mL

Analytical Instrument: HACH® DR/890 Colorimeter

Filtration:
Filter Type: Syringe Filter (Surfactant-Free Cellulose Acetate Membrane)
Pore Size: 0.2 μm

Phosphorus is commonly found in waste water systems as both reactive and non-reactive phosphorus. To determine the abilities of CeCl₃ to remove both reactive and non-reactive phosphorus species, reactions were performed by the addition of CeCl₃ to both influent and effluent samples of waste water from a representative water treatment facility. Cerium (III) chloride was added in an equimolar ratio with the total phosphorus measured in solution, to ensure the ability of the reagent to react with most, if not all, phosphorus-containing compound(s) in solution. Following the addition of CeCl₃, the samples were allowed to mix for 16 hours via magnetic stir before being filtered and analyzed for reactive and total phosphorus.

Reactive phosphorus was measured (in terms of P) using a HACH® DR/890 Colorimeter. The analysis involves the reaction between orthophosphate and molybdate in an acidic medium to produce heteropolyacids which are then reduced using ascorbic acid. This reduced form of phosphomolybdate produces an intense molybdenum blue color which may be analyzed in accordance with Beer's Law.

Total phosphorus was measured (in terms of P) using a HACH® DR/890 Colorimeter. This analysis was performed similar to the analysis for reactive orthophosphate, but first required a pretreatment to digest the compound and oxidize the non-reactive phosphorus to reactive orthophosphate. This digestion involved heating the solution to 150° C. for 30 minutes in a sulfuric acid medium in the presence of potassium persulfate. The difference between reactive and total phosphorus is then calculated to determine the concentration of non-reactive phosphorus in solution.

TABLE 8
Waste Water Samples Treated with CeCl₃

| Test | | Molar Ratio | [CeCl₃] | Volume Added |
|---|---|---|---|---|
| No. | Sample Type | Ce:P | (M) | CeCl₃ (mL) |
| 1 | Influent | 1 | 0.22 | 0.401 |
| 2 | Influent | 1 | 0.22 | 0.401 |
| 3 | Effluent | 1 | 0.22 | 0.262 |
| 4 | Effluent | 1 | 0.22 | 0.262 |

As can be seen from Tables 9-11, cerium (III) chloride demonstrated the ability to remove both reactive and non-reactive phosphorus with over 90% removal rate on an equimolar addition. This resulted in a removal capacity of approximately 176 mg P/g theoretical rare earth oxide, which is near the theoretical removal rate of 180 mg P/g CeO₂. This demonstrates a high specificity of CeCl₃ for phosphorus, both reactive and non-reactive, in a waste water stream.

TABLE 9
Waste Water Treatment Results - Reactive Phosphorus

| | | Final Reactive | | |
|---|---|---|---|---|
| | | [P] | | Percent P |
| Test No. | Sample Type | (mg/L) | Final pH | Removal |
| 1 | Influent | 0.06 | 7.65 | 99.4% |
| 2 | Influent | 0.05 | 7.31 | 99.4% |
| 3 | Effluent | 0.07 | 7.43 | 99.0% |
| 4 | Effluent | 0.06 | 7.45 | 99.1% |

TABLE 10
Waste Water Treatment Results - Total Phosphorus

| | | | | | Total P |
|---|---|---|---|---|---|
| | | Final | | | Removal |
| | | Total | | | Capacity |
| Test | Sample | [P] | Final | Percent P | (mg P/g |
| No. | Type | (mg/L) | pH | Removal | CeO₂) |
| 1 | Influent | 0.19 | 7.65 | 98.2% | 176.7 |
| 2 | Influent | 0.23 | 7.31 | 97.9% | 176.2 |
| 3 | Effluent | 0.15 | 7.43 | 97.9% | 176.1 |
| 4 | Effluent | 0.25 | 7.45 | 96.5% | 173.7 |

TABLE 11
Waste Water Treatment Results - Non-Reactive Phosphorus

| | | Final Non-Reactive | | |
|---|---|---|---|---|
| | | [P] | | Percent P |
| Test No. | Sample Type | (mg/L) | Final pH | Removal |
| 1 | Influent | 0.13 | 7.65 | 91.3% |
| 2 | Influent | 0.17 | 7.31 | 88.7% |
| 3 | Effluent | 0.09 | 7.43 | 90.0% |
| 4 | Effluent | 0.19 | 7.45 | 78.2% |

### Example 6

The goal of this experiment was to remove organophosphate from solution by using CeCl₃ and CeO₂

The parameters for the experiment are as follows:

Materials: HEPES Sodium Salt, D.I. Water, CeCl₃, CeO₂, trisodium trimetaphosphate (Na₃P₃O₉), trimethyl phosphate ((CH₃)₃PO₄), triethylphosphine oxide ((C₂H₅)₃PO, methyltriphenyl phosphonium iodide (CH₃P(C₆H₅)₃I

Solutions:

TABLE 12
Stock Solutions

| Solution | Concentration (M) |
|---|---|
| CeCl₃ | 0.22 |
| Na₃P₃O₉ | 0.042 |
| (CH₃)₃PO₄ | 0.126 |
| (C₂H₅)₃PO | 0.126 |
| HEPES | 0.012 |

Reaction Volume: 500 mL per sample

Reaction Time: 24 hours

Filtration:
Filter Type: Membrane
Pore Size: 0.2 μm

Analytical Instrument: HACH® DR/890 Colorimeter

Procedure:

For batch reactions, the procedure was to add stock solutions of Trisodium trimetaphosphate, trimethyl phosphate, tryelthylphosphine and a solid compound of Methyltriphenyl Iodide to 4 2000 mL solutions of HEPES in D.I water buffered to 7.5 pH with a (PO₄)³⁻ concentration of 12 mg/L. The methyltriphenyl iodide was added directly to the solutions because of its low solubility. The solutions were then transferred to 4 separate 500 mL beakers. On a 1:1 molar ratio of Ce:P CeCl₃ from the plant was added to 3 of the 4 samples and stirred for 24 h using a stir bar. All 16 samples were then syringe filtered with 0.2 μm filters. A digestion was then performed and tested using the HACH® colorimeter. The control for each compound was tested in triplicate.

For isotherms, the procedure was to add stock solutions of trisodium trimetaphosphate, trimethyl phosphate, tryelthylphosphine and a solid compound of methyltriphenyl iodide to 4 2000 mL solutions of HEPES in D.I water and buffered to 7.5 pH with a (PO₄)³⁻ concentration of 12 mg/L. The methyltriphenyl iodide was added directly to the solution because of its low solubility. The solutions were then separated into 500 mL Nalgene® bottles. 500 mg of CeO₂ from bucket 14 was weighed and added to 3 of the 4 500 mL Nalgene® bottles. They were then placed in the tumbler and tumbled for 24 h. All 16 samples were then syringe filtered with 0.2 μm filters. The samples were diluted by a factor of 4 since the test method used had a detection limit of 0.00 to 3.50 mg/L (PO₄)³⁻. A digestion was then performed and tested using the HACH® colorimeter. The control for each compound was tested in triplicate.

Results:

The results are presented in Tables 13-14 below.

TABLE 13
Batch Reactions with CeCl₃

| | | Total | | | | | | | | |
|---|---|---|---|---|---|---|---|---|---|---|
| | | sample | REO | Initial | Moles of P: | Initial | | Final | Final | |
| | | volume | added | [PO4]3− | Moles of | [Compound] | | [PO4]3− | [Compund] | |
| Sample | Compound Name | (ml) | (mL) | (mg/L) | Compound | (mg/L) | Initial pH | (mg/L) | (mg/L) | Final pH |
| 1 | Trisodium | 500 | 0.288 | 12.61 | 3 | 13.54 | 7.54 | 3.68 | 3.95 | 6.04 |
| 2 | trimetaphosphate | 500 | 0.288 | 12.61 | 3 | 13.54 | 7.54 | 4.08 | 4.38 | 6.05 |
| 3 | | 500 | 0.288 | 12.61 | 3 | 13.54 | 7.54 | 4.44 | 4.77 | 6.15 |
| 4 | Trimethyl | 500 | 0.288 | 13.09 | 1 | 1.94 | 7.48 | 13.72 | 2.03 | 6.47 |
| 5 | Phosphate | 500 | 0.288 | 13.09 | 1 | 1.94 | 7.48 | 13.80 | 2.04 | 6.74 |
| 6 | | 500 | 0.288 | 13.09 | 1 | 1.94 | 7.48 | 13.96 | 2.07 | 6.80 |
| 7 | Triethylphosphine | 500 | 0.288 | 12.33 | 1 | 17.48 | 7.48 | 12.84 | 18.20 | 6.01 |
| 8 | Oxide | 500 | 0.288 | 12.33 | 1 | 17.48 | 7.48 | 13.64 | 19.33 | 5.98 |
| 9 | | 500 | 0.288 | 12.33 | 1 | 17.48 | 7.48 | 14.28 | 20.24 | 5.91 |
| 10 | Methyltriphenyl | 500 | 0.288 | 12.71 | 1 | 54.35 | 7.50 | 12.64 | 54.07 | 5.82 |
| 11 | phosphonium | 500 | 0.288 | 12.71 | 1 | 54.35 | 7.50 | 13.44 | 57.49 | 5.78 |
| 12 | iodide | 500 | 0.288 | 12.71 | 1 | 54.35 | 7.50 | 14.08 | 60.23 | 5.86 |

| | | | | | | Average Removal |
|---|---|---|---|---|---|---|
| | | | Compound | | | Capacity |
| | | % removal of | removed | Removal Capacity | Average % Removal for | (mg compound/g |
| Sample | Compound Name | Compound | (mg) | (mg compound/g REO) | Compound | REO) |
| 1 | Trisodium | 70.82% | 4.80 | 440.51 | 67.76% | 421.40 |
| 2 | trimetaphosphate | 67.65% | 4.58 | 420.72 | | |
| 3 | | 64.80% | 4.39 | 402.97 | | |
| 4 | Trimethyl | −4.80% | −4.65E−02 | −4.27 | −5.61% | −5.00 |
| 5 | Phosphate | −5.41% | −5.24E−02 | −4.82 | | |
| 6 | | −6.63% | −6.43E−02 | −5.91 | | |
| 7 | Triethylphosphine | −4.12% | −0.36 | −33.07 | −10.17% | −81.67 |
| 8 | Oxide | −10.61% | −0.93 | −85.14 | | |
| 9 | | −15.80% | −1.38 | −126.80 | | |
| 10 | Methyltriphenyl | 0.51% | 0.14 | 12.83 | −5.36% | −133.86 |
| 11 | phosphonium | −5.78% | −1.57 | −144.34 | | |
| 12 | iodide | −10.82% | −2.94 | −270.07 | | |

TABLE 14
Isotherms using CeO₂

| | | Total | | | | | | | |
|---|---|---|---|---|---|---|---|---|---|
| | | sample | REO | Initial | Moles of P: | Initial | | Final | Final |
| | | volume | added | [PO4]3− | Moles of | [Compound] | | [PO4]3− | [Compund] |
| Sample | Compound Name | (ml) | (mL) | (mg/L) | Compound | (mg/L) | Initial pH | (mg/L) | (mg/L) |
| 13 | Trisodium | 500 | n/a | 12.77 | 3 | 13.71 | 7.56 | 3.08 | 3.31 |
| 14 | trimetaphosphate | 500 | n/a | 12.77 | 3 | 13.71 | 7.56 | 3.44 | 3.69 |
| 15 | | 500 | n/a | 12.77 | 3 | 13.71 | 7.56 | 3.84 | 4.12 |
| 16 | Trimethyl | 500 | n/a | 12.69 | 3 | 0.63 | 7.54 | 12.84 | 0.63 |
| 17 | Phosphate | 500 | n/a | 12.69 | 1 | 1.88 | 7.54 | 13.68 | 2.03 |
| 18 | | 500 | n/a | 12.69 | 1 | 1.88 | 7.54 | 15.00 | 2.22 |
| 19 | Triethylphosphine | 500 | n/a | 13.15 | 1 | 18.63 | 7.46 | 12.00 | 17.01 |
| 20 | Oxide | 500 | n/a | 13.15 | 1 | 18.63 | 7.46 | 12.48 | 17.69 |
| 21 | | 500 | n/a | 13.15 | 1 | 18.63 | 7.46 | 12.60 | 17.86 |
| 22 | Methyltriphenyl | 500 | n/a | 12.28 | 1 | 52.52 | 7.48 | 12.56 | 53.73 |
| 23 | phosphonium | 500 | n/a | 12.28 | 1 | 52.52 | 7.48 | 12.68 | 54.24 |
| 24 | iodide | 500 | n/a | 12.28 | 1 | 52.52 | 7.48 | 13.24 | 56.63 |

| | | | | | | Average Removal |
|---|---|---|---|---|---|---|
| | | | Compound | | Average % | Capacity |
| | | % removal of | removed | Removal Capacity | Removal for | (mg compound/g |
| Sample | Compound Name | Compound | (mg) | (mg compound/g REO) | Compound | REO) |
| 13 | Trisodium | 75.88% | 5.20 | 1.04E−02 | 72.96% | 9.95E−03 |
| 14 | trimetaphosphate | 73.07% | 5.01E+00 | 9.92E−03 | | |
| 15 | | 69.93% | 4.79 | 9.54E−03 | | |
| 16 | Trimethyl | −1.17% | −3.65E−03 | −7.34E−06 | −9.05% | −1.64E−04 |
| 17 | Phosphate | −7.78% | −7.32E−02 | −1.46E−04 | | |
| 18 | | −18.18% | −1.71E−01 | −3.39E−04 | | |
| 19 | Triethylphosphine | 8.71% | 0.81 | 1.62E−03 | 5.97% | 1.11E−03 |
| 20 | Oxide | 5.06% | 0.47 | 9.33E−04 | | |
| 21 | | 4.15% | 3.86E−01 | 7.81E−04 | | |
| 22 | Methyltriphenyl | −2.29% | −0.60 | −1.20E−03 | −4.46% | −2.34E−03 |
| 23 | phosphonium | −3.27% | −0.86 | −1.71E−03 | | |
| 24 | iodide | −7.83% | −2.06 | −4.11E−03 | | |

Conclusions:

CeCl₃ batch reactions showed a definite removal of trisodium trimetaphosphate, removing trisodium trimetaphosphate from all three samples, with CeCl₃ removing an average of 67.76% trisodium trimetaphosphate from solution. The remaining organophosphates; trimethyl phosphate, triethylphosphine oxide and methyltriphenol phosphonium iodide, showed no removal from solution with the addition of CeCl₃.

CeO₂ isotherms showed a definite removal of trisodium trimetaphosphate. CeO₂ removed an average of 72.96% trisodium trimetaphosphate from solution. Triethylphosphine oxide exhibited a loss in solution with the addition of CeO₂, with an average removal of 5.97%. These two organophosphate compounds exhibited removal in all of the three samples tested. Trimethyl phosphate and methyltriphenol phosphonium iodide showed no removal with the addition of CeO₂ to the solutions.

### Example 7

The goal of this experiment was to remove organophosphate from solution by using CeCl₃ and CeO₂

The parameters of the experiment were as follows:

Materials: HEPES sodium salt, D.I. sater, CeO₂ (bucket 14), fenamiphos (C₁₃H₂₂NO₃PS), profenofos (C₁₁H₁₅BrClO₃PS), methamidophos (C₂H₈NO₂PS), dicrotophos (C₈H₁₆NO₅P)

Solutions:

TABLE 15
Stock Solutions

| Solution | Concentration (M) |
|---|---|
| HEPES | 0.012 |

Reaction Volume: 500 mL per sample

Reaction Time: 24 hours

Filtration:
Filter Type: Membrane
Pore Size: 0.2 μm

Analytical Instrument: HACH® DR/890 Colorimeter

Procedure:

The procedure for isotherms was as follows:

According to a concentration of 3.5 mg/L [PO₄]³⁻ and using a molar ratio of organophosphates (pesticides) to [PO₄]³⁻ an amount of compound was obtained and added to 2000 mL solutions of HEPES in D.I water and buffered to 7.5 pH. The fenamiphos remained stirring over night to allow the compound to dissolve in solution. The solutions were then separated into 4 500 mL Nalgene® bottles. 500 mg of CeO₂ from bucket 14 was weighed and added to 3 of the 4 500 mL Nalgene® bottles. They were then placed in the tumbler and tumbled for 24 h. All 16 samples were then syringe filtered with 0.2 μm filters. A digestion was then performed on the pesticides and tested using the HACH® colorimeter. The control for each compound was tested in triplicate.

Results:

The results are presented in Tables 16-17 below:

TABLE 16
Addition of the pesticide compounds in solution

| | Molecular | Concentration | | | moles of | | |
|---|---|---|---|---|---|---|---|
| | weight of | of [PO4]3− | Solutions | [PO4]3− | compound: | Compound | Compound |
| Compound Name | Compound | (mg/L) | (mL) | (moles) | moles of [PO4]3− | (moles) | (mg) |
| Fenamiphos | 303.36 | 3.5 | 2000 | 7.39E−05 | 1 | 7.39E−05 | 22.4 |
| Profenofos | 373.63 | 3.5 | 2000 | 7.39E−05 | 1 | 7.39E−05 | 27.6 |
| Methamidophos | 141.13 | 3.5 | 2000 | 7.39E−05 | 1 | 7.39E−05 | 10.4 |
| Dicrotophos | 237.19 | 3.5 | 2000 | 7.39E−05 | 1 | 7.39E−05 | 17.5 |

TABLE 17
Isotherms using CeO₂

| | | | | | moles of | | | |
|---|---|---|---|---|---|---|---|---|
| | | Total sample | [REO] | Initial | compound: | Initial | Final | Final |
| | | volume | added | [PO4]3− | moles of | [Compound] | [PO4]3− | [Compund] |
| Sample | Compound Name | (ml) | (g) | (mg/L) | [PO4]3− | (mg/L) | (mg/L) | (mg/L) |
| 1 | Fenamiphos | 500 | 0.5047 | 0.34 | 1 | 1.10 | 0.37 | 1.18 |
| 2 | | 500 | 0.5007 | 0.34 | 1 | 1.10 | 0.42 | 1.34 |
| 3 | | 500 | 0.5036 | 0.34 | 1 | 1.10 | 0.49 | 1.57 |
| 4 | Profenofos | 500 | 0.5078 | 3.49 | 1 | 13.72 | 3.55 | 13.97 |
| 5 | | 500 | 0.5042 | 3.49 | 1 | 13.72 | 3.51 | 13.81 |
| 6 | | 500 | 0.5044 | 3.49 | 1 | 13.72 | 3.83 | 15.07 |
| 7 | Methamidophos | 500 | 0.5056 | 4.36 | 1 | 6.48 | 3.93 | 5.84 |
| 8 | | 500 | 0.5050 | 4.36 | 1 | 6.48 | 3.76 | 5.59 |
| 9 | | 500 | 0.5025 | 4.36 | 1 | 6.48 | 3.99 | 5.93 |
| 10 | Dicrotophos | 500 | 0.5070 | 3.27 | 1 | 8.17 | 3.23 | 8.07 |
| 11 | | 500 | 0.5063 | 3.27 | 1 | 8.17 | 3.30 | 8.24 |
| 12 | | 500 | 0.5067 | 3.27 | 1 | 8.17 | 3.36 | 8.39 |

| | | | | | | Average |
|---|---|---|---|---|---|---|
| | | | | | | Removal |
| | | | Compound | Removal Capacity | Average % | Capacity |
| | | % removal of | removed | (mg compound/g | Removal for | (mg compound/ |
| Sample | Compound Name | Compound | (mg) | REO) | Compound | g REO) |
| 1 | Fenamiphos | −7.77% | −0.04 | −0.08 | −24.28% | −0.26 |
| 2 | | −22.34% | −0.12 | −0.24 | | |
| 3 | | −42.73% | −0.23 | −0.47 | | |
| 4 | Profenofos | −1.83% | −1.25E−01 | −0.25 | −4.12% | −0.56 |
| 5 | | −0.68% | −4.66E−02 | −0.09 | | |
| 6 | | −9.86% | −6.76E−01 | −1.34 | | |
| 7 | Methamidophos | 9.92% | 0.32 | 0.64 | 10.76% | 0.69 |
| 8 | | 13.82% | 0.45 | 0.89 | | |
| 9 | | 8.55% | 0.28 | 0.55 | | |
| 10 | Dicrotophos | 1.21% | 0.05 | 0.10 | −0.83% | −0.07 |
| 11 | | −0.93% | −0.04 | −0.07 | | |
| 12 | | −2.76% | −0.11 | −0.22 | | |

Conclusions:

After performing the isotherms of 4 different pesticides, it is concluded that fenamiphos and profenofos showed no removal with the addition of CeO₂. Methamidophos expressed a definite removal of organophosphates in the solution when using the CeO₂. Dicrotophos had an apparent removal of organophosphate removing only one of the three samples. Two of the four pesticides tested had to be heated to 75° C. and fenamiphos stirred in solution for over 16 h. There may have been a degeneration of the pesticide fenamiphos because the concentrations of the samples and the control came in much lower than the expected 3.5 mg/L.

A number of variations and modifications of the disclosure can be used. One of more embodiments of the disclosure can be used separately and in combination. That is, any embodiment alone can be used and all combinations and permutations thereof can be used. It would be possible to provide for some features of the disclosure without providing others.

The present disclosure, in various embodiments, configurations, or aspects, includes components, methods, processes, systems and/or apparatus substantially as depicted and described herein, including various embodiments, configurations, aspects, sub-combinations, and subsets thereof. Those of skill in the art will understand how to make and use the various embodiments, configurations, or aspects after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that any claim and/or combination of claims require more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment.

Moreover, though the description of the disclosure has included descriptions of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
contacting an aqueous medium comprising a phosphorus-containing target material with a rare earth-containing additive to remove at least a portion of the phosphorus-containing target material from the aqueous medium to form a treated aqueous medium, wherein the phosphorus-containing target material comprises one or more of phosphoric acid, phosphinate, non-fluoridated phosphonates, phosphonic acid, phosphinic acid, phosphine oxide, metaphosphate, phosphonite, thiophosphate, thiophosphyoryl amide, and phosphatidylcholine.

2. The method of claim 1, wherein the rare earth-containing additive is primarily in the form of cerium (IV), cerium (III) or a mixture of cerium (IV) and cerium (III).

3. The method of claim 1, wherein the contacting step comprises the sub-steps:
contacting the aqueous medium with an oxidizing agent to oxidize the phosphorus-containing target material to form an oxidized phosphorus-containing target material, the oxidized phosphorus-containing target mater having one or both of a different structure and composition than the phosphorus-containing target material; and
thereafter contacting, in the aqueous medium, the rare earth-containing additive with the oxidized phosphorus-containing target material to remove the oxidized phosphorus-containing target material.

4. The method of claim 1, wherein the contacting step comprises the sub-steps:
contacting the aqueous medium with a reducing agent to reduce the phosphorus-containing target material to form a reduced phosphorus-containing target material, the reduced phosphorus-containing target material having one or both of a different structure and composition than the phosphorus-containing target material; and
thereafter contacting, in the aqueous medium, the rare earth-containing additive with the reduced target phosphorus-containing target material to remove the reduced phosphorus-containing target material.

5. The method of claim 1, wherein the contacting step comprises the sub-steps:
contacting the aqueous medium with a base and/or base equivalent to convert the phosphorus-containing target material to a primary species different from the phosphorus-containing target material; and
thereafter contacting, in the aqueous medium, the rare earth-containing additive with the primary species to remove the primary species.

6. The method of claim 1, wherein the contacting step comprises the sub-steps:
contacting the aqueous medium with an acid and/or acid equivalent to convert the phosphorus-containing target material to a primary species different from the phosphorus-containing target material; and
thereafter contacting, in the aqueous medium, the rare earth-containing additive with the primary species to remove the primary species.

7. The method of claim 1, wherein the rare earth-containing additive is water-soluble.

8. The method of claim 1, wherein the rare earth-containing additive is water-insoluble.

9. The method of claim 1, wherein the phosphorus-containing target material is selected from the group consisting essentially of phosphoric acid, phosphinate, phosphinite, non-fluoridated phosphonates, phosphonic acid, phosphinic acid, phosphonite, thiophosphate, and thiophosphyoryl ester.

10. The method of claim 1, wherein the phosphorus-containing target material comprises phosphatidylcholine.

11. The method of claim 1, wherein the phosphorus-containing target material comprises a thiophosphyoryl amide.

12. A composition, comprising:
an aqueous medium,
a rare earth-containing additive,
a phosphorus-containing target material comprising one or more of one or more of phosphoric acid, phosphinate, phosphinite, non-fluoridated phosphonates, phosphonic acid, phosphinic acid, phosphine oxide, metaphosphate, phosphonite, thiophosphate, thiophosphyoryl ester, thiophosphyoryl amide, and phosphatidylcholine, and
a target-laden rare earth composition formed by the rare earth-containing additive and the phosphorus-containing target material.

13. The composition of claim 12, wherein the rare earth-containing additive comprises primarily cerium and wherein the target-laden rare earth composition is a complex formed by the rare earth-containing additive and phosphorus-containing target material.

14. The composition of claim 12, wherein the rare earth-containing additive comprises primarily cerium and wherein the target-laden rare earth composition is formed by sorption of the phosphorus-containing target material by the rare earth-containing additive.

15. The composition of claim 12, wherein the rare earth-containing additive comprises primarily cerium and wherein the target-laden rare earth composition is formed by a chemical reaction between the phosphorus-containing target material and the rare earth-containing additive.

16. The composition of claim 12, wherein the rare earth-containing additive is water-soluble.

17. The composition of claim 12, wherein the rare earth-containing additive is water-insoluble.

18. The composition of claim 12, wherein the phosphorus-containing target material is selected from the group consisting essentially of phosphoric acid, phosphinate, phosphinite, non-fluoridated phosphonates, phosphonic acid, phosphinic acid, phosphonite, thiophosphate, and thiophosphyoryl ester.

19. The composition of claim 12, wherein the phosphorus-containing target material comprises phosphatidylcholine.

20. The composition of claim 12, wherein the phosphorus-containing target material comprises a thiophosphyoryl amide.

21. A process, comprising:
receiving an aqueous medium comprising a target material, the target material comprising both reactive and non-reactive phosphates; and
contacting the aqueous medium with a rare earth-containing additive to remove at least most of the reactive and non-reactive phosphates.

22. The process of claim 21, wherein the reactive phosphate is in the form of an anion and the non-reactive phosphate is in the form of a cation, neutral species, and/or colloid or suspension.

23. The process of claim 22, wherein at least most of the rare earth-containing additive is water soluble.

24. The process of claim 22, wherein at least most of the rare earth-containing material is water insoluble.

25. The process of claim 21, further comprising before the contacting step:
converting at least a portion of the non-reactive phosphate to reactive phosphate.

26. The process of claim 21, further comprising before the contacting step:
converting at least a portion of the reactive phosphate to non-reactive phosphate.
